(19) United States
(12) Patent Application Publication
(10) Pub. No.: US 2026/0189510 A1
(43) Pub. Date: Jul. 2, 2026

(54) COMMUNICATION CONTROL APPARATUS, COMMUNICATION SYSTEM AND COMMUNICATION CONTROL METHOD

(71) Applicant: NTT, Tokyo (JP)

(72) Inventors: Yuka OKAMOTO, Musashino-shi (JP); Hirotaka UJIKAWA, Musashino-shi (JP); Yoshihito SAKAI, Musashino-shi (JP); Tatsuya SHIMADA, Musashino-shi (JP); Takumi HARADA, Musashino-shi (JP)

(73) Assignee: NTT, Tokyo (JP)

(21) Appl. No.: 19/130,036

(22) PCT Filed: Dec. 22, 2022
(86) PCT No.: PCT/JP2022/047282

§ 371 Date: May 14, 2025

(51) Int. Cl. H04L 47/127; H04W 40/12

(52) U.S. Cl. CPC H04L 47/127; H04W 40/12

(57) ABSTRACT

A communication control device includes: a prediction unit that predicts a future traffic amount of a communication link; a prediction accuracy calculation unit that calculates prediction accuracy on the basis of the predicted traffic amount in a first period and the actual traffic amount; a threshold value calculation unit that calculates a threshold value on the basis of the prediction accuracy and a transmission ability; a communication terminal number estimation unit that estimates the number of terminals in communication; a transmission duration time calculation unit that calculates a transmission duration time of the traffic per terminal on the basis of the traffic amount in a second period, the number of terminals in communication, an average rate, and a transmission cycle and a transmission interval of traffic; a congestion determination unit that determines whether or not the congestion will occur on the basis of the traffic amount in the second period and the threshold value; and a path switching determination unit that determines whether or not to perform path switching to reduce the traffic amount on the basis of a congestion duration time calculated on the basis of the transmission duration time in a case where it is determined that the congestion will occur, the path switching determination unit providing an instruction to perform the path switching to a transfer device in a case where it is determined to be necessary to perform the path switching.

### TECHNICAL FIELD

The present invention relates to a communication control apparatus, a communication system and a communication control method.

### BACKGROUND ART

In a case where communication is simultaneously performed by a plurality of communication devices, such as a case where a plurality of upper-order devices and a plurality of lower-order devices communicate with each other, a communication delay may occur due to occurrence of congestion. Congestion may be able to be solved by changing a connection relationship between the upper-order devices and the lower-order devices by switching communication paths. If communication traffic (hereinafter, simply referred to as “traffic”) concentrated on a specific communication device (for example, an upper-order device) can be distributed to a plurality of communication devices by switching the communication paths, the congestion can be solved, and the communication delay can be reduced. For example, a communication system in the related art calculates a value indicating a degree of congestion (hereinafter, referred to as a “congestion value”) of each communication path, and switches the communication paths when the congestion value of any of the communication paths exceeds a predetermined threshold value (see Non Patent Literature 1, for example).

### CITATION LIST

### Non Patent Literature

Non Patent Literature 1: Wenjun Wu, et al., “RavenFlow: Congestion-Aware Load Balancing in 5G base station Network,” 2022 IEEE International Symposium on Circuits and Systems (ISCAS), IEEE, October 2022, Internet <https://ieeexplore.ieee.org/abstract/document/9180892>

### SUMMARY OF INVENTION

### Technical Problem

The communication system in the related art calculates the congestion value using information regarding a traffic situation of each communication path, and switches the communication paths in a case where the congestion value of any of the communication paths exceeds the threshold value. Therefore, according to the communication system in the related art, a state in which congestion has occurred continues until the switching of the communication paths is completed after occurrence of the congestion. Therefore, a method of avoiding the occurrence of congestion by predicting future traffic of each communication path and switching the communication paths in advance on the basis of a prediction result is conceivable.

However, it generally takes a certain amount of time to switch the communication paths. Also, such time required for switching the communication paths is also a factor in the communication delay. Therefore, even if the future traffic of each communication path is predicted to avoid the occurrence of congestion, the magnitude of the communication delay due to the switching of the communication paths may exceed the magnitude of the communication delay due to congestion in a situation where the switching of the communication paths frequently occurs. In this case, the communication delay as a whole is actually increased by switching the communication paths. In this manner, there is a problem that the communication delay may not be able to be reduced by the method of determining whether or not to switch the communication paths on the basis of only an actually measured value or a prediction value of the traffic in the related art.

In view of the above circumstances, an object of the present invention is to provide a communication control apparatus, a communication system and a communication control method capable of reducing a communication delay due to congestion in consideration of a communication delay due to switching of communication paths.

### Solution to Problem

An aspect of the present invention is a communication control device including: a prediction unit that predicts a future traffic amount of a communication link on the basis of prediction information used to predict the traffic amount; a prediction accuracy calculation unit that calculates prediction accuracy on the basis of the traffic amount of the communication link in a first period predicted by the prediction unit and the actual traffic amount of the communication link in the first period; a threshold value calculation unit that calculates a threshold value used to determine whether or not congestion will occur on the basis of the prediction accuracy calculated by the prediction accuracy calculation unit and a transmission ability of the communication link; a communication terminal number estimation unit that estimates the number of terminals in communication which is the number of terminals that are performing communication through the communication link; a transmission duration time calculation unit that calculates a transmission duration time of the traffic per terminal on the basis of the traffic amount in a second period, which is a period later than the first period, predicted by the prediction unit, the number of terminals in communication estimated by the communication terminal number estimation unit, an average rate per terminal, a transmission cycle of traffic, and a transmission interval of the traffic; a congestion determination unit that determines whether or not the congestion will occur on the basis of the traffic amount in the second period predicted by the prediction unit and the threshold value calculated by the threshold value calculation unit; and a path switching determination unit that determines whether or not to perform path switching to reduce the traffic amount of the communication link, due to which occurrence of the congestion is predicted, on the basis of a time calculated using the transmission duration time calculated by the transmission duration time calculation unit in a case where the congestion determination unit determines that the congestion will occur, the path switching determination unit providing an instruction to perform the path switching to a transfer device configuring a communication network in a case where it is determined to be necessary to perform the path switching.

Also, an aspect of the present invention is a communication system including a communication device; a transfer device that configures a communication network and transfers a signal transmitted or received by the communication device via a communication link; and a communication control device that performs traffic control in the communication network, in which the communication control device includes a prediction unit that predicts a future traffic amount of a communication link on the basis of prediction information used to predict the traffic amount, a prediction accuracy calculation unit that calculates prediction accuracy on the basis of the traffic amount of the communication link in a first period predicted by the prediction unit and the actual traffic amount of the communication link in the first period; a threshold value calculation unit that calculates a threshold value used to determine whether or not congestion will occur on the basis of the prediction accuracy calculated by the prediction accuracy calculation unit and a transmission ability of the communication link; a communication terminal number estimation unit that estimates the number of terminals in communication which is the number of terminals that are performing communication through the communication link; a transmission duration time calculation unit that calculates a transmission duration time of the traffic per terminal on the basis of the traffic amount in a second period, which is a period later than the first period, predicted by the prediction unit, the number of terminals in communication estimated by the communication terminal number estimation unit, an average rate per terminal, a transmission cycle of traffic, and a transmission interval of the traffic; a congestion determination unit that determines whether or not the congestion will occur on the basis of the traffic amount in the second period predicted by the prediction unit and the threshold value calculated by the threshold value calculation unit; and a path switching determination unit that determines whether or not to perform path switching to reduce the traffic amount of the communication link, due to which occurrence of the congestion is predicted, on the basis of a congestion measurement time calculated on the basis of the transmission duration time calculated by the transmission duration time calculation unit in a case where the congestion determination unit determines that the congestion will occur, the path switching determination unit providing an instruction to perform the path switching to the transfer device configuring a communication network in a case where it is determined to be necessary to perform the path switching.

Moreover, an aspect of the present invention is a communication control method performed by a computer including: a predicting step of predicting a future traffic amount of a communication link on the basis of prediction information used to predict the traffic amount; a prediction accuracy calculation step of calculating prediction accuracy on the basis of the traffic amount of the communication link in a first period predicted in the predicting step and the actual traffic amount of the communication link in the first period; a threshold value determination step of determining a threshold value used to determine whether or not congestion will occur on the basis of the prediction accuracy calculated in the prediction accuracy calculation step and a transmission ability of the communication link; a communication terminal number estimation step of estimating the number of terminals in communication which is the number of terminals that are performing communication through the communication link; a transmission duration time calculation step of calculating a transmission duration time of the traffic per terminal on the basis of the traffic amount in a second period, which is a period later than the first period, predicted in the predicting step, the number of terminals in communication estimated in the communication terminal number estimation step, an average rate per terminal, a transmission cycle of traffic, and a transmission interval of the traffic; a congestion determination step of determining whether or not the congestion will occur on the basis of the traffic amount in the second period predicted in the predicting step and the threshold value determined in the threshold value determination step; and a path switching determination step of determining whether or not to perform path switching to reduce the traffic amount of the communication link, due to which occurrence of the congestion is predicted, on the basis of a congestion duration time calculated on the basis of the transmission duration time calculated in the transmission duration time calculation step in a case where it is determined that the congestion will occur in the congestion determination step, and providing an instruction to perform the path switching to a transfer device configuring a communication network in a case where it is determined to be necessary to perform the path switching.

### Advantageous Effects of Invention

According to the present invention, it is possible to reduce a communication delay due to congestion in consideration of a communication delay due to switching of communication paths.

### BRIEF DESCRIPTION OF DRAWINGS

FIG. 1 is a diagram illustrating a configuration of a communication system 1 that is an example of a communication system in the related art.

FIG. 2 is a diagram illustrating a configuration of a mobile communication system 10 that is an example of the communication system in the related art.

FIG. 3 is a block diagram illustrating a configuration of a switching instruction device 17 in the mobile communication system 10 that is an example of the communication system in the related art.

FIG. 4 is a diagram illustrating a flow of processing performed by the switching instruction device 17 in the mobile communication system 10 that is an example of the communication system in the related art.

FIG. 5 is a diagram illustrating an example of a communication system including a plurality of upper-order devices, a plurality of lower-order devices, and a transfer device 15.

FIG. 6 is a diagram illustrating an example of a traffic amount of traffic transmitted from each DU.

FIG. 7 is a diagram illustrating an example of a traffic amount of traffic received by each CU.

FIG. 8 is a diagram illustrating a link after path switching of the communication system including the plurality of upper-order devices, the plurality of lower-order devices, and the transfer device 15.

FIG. 9 is a diagram illustrating a change in a traffic amount due to path switching and occurrence of a switching delay in the communication system including the plurality of upper-order devices, the plurality of lower-order devices, and the transfer device 15.

FIG. 10 is a diagram illustrating an example of a relationship between a congestion delay and a switching delay.

FIG. 11 is a diagram for explaining the magnitude of congestion delay in a case where path switching is not performed when a duration time of a congestion state is relatively long.

FIG. 12 is a diagram for explaining the magnitude of congestion delay in a case where path switching is not performed when the duration time of a congestion state is relatively short.

FIG. 13 is a diagram for explaining the magnitude of switching delay in a case where path switching is performed when the duration time of a congestion state is relatively short.

FIG. 14 is a diagram illustrating an example of a timing for determining the duration time of the congestion state. In the graph illustrated in FIG. 14, the horizontal axis represents a time (or a clock time), and the vertical axis represents a traffic amount of traffic received by each CU.

FIG. 15 is a diagram illustrating an example of a relationship between a traffic amount of a DU and a traffic amount per UE.

FIG. 16 is a diagram illustrating an example of a relationship among the number of terminals, a transmission rate, and a communication duration time.

FIG. 17 is a diagram illustrating a configuration of a communication system 1a according to a first embodiment of the present invention.

FIG. 18 is a flowchart illustrating a flow of processing of calculating a congestion duration time performed by a future congestion estimation unit 81 according to the first embodiment of the present invention.

FIG. 19 is a diagram for explaining an example of an occurrence frequency (ratio) for each congestion duration time.

FIG. 20 is a flowchart illustrating a specific example of the processing of calculating the congestion duration time performed by the future congestion estimation unit 81 according to the first embodiment of the present invention.

FIG. 21 is a flowchart illustrating a numerical value example of the processing of calculating the congestion duration time performed by the future congestion estimation unit 81 according to the first embodiment of the present invention.

FIG. 22 is a flowchart illustrating a flow of processing of determining whether or not to perform the path switching by a switching determination unit 75a according to the first embodiment of the present invention.

FIG. 23 is a diagram illustrating a configuration of a communication system 1b according to a second embodiment of the present invention.

FIG. 24 is a flowchart illustrating a specific example of processing of acquiring a congestion duration time performed by a future congestion estimation unit 81b according to the second embodiment of the present invention.

FIG. 25 is a diagram illustrating an example of congestion duration time information stored in a congestion duration time information storage unit 85 according to the second embodiment of the present invention.

FIG. 26 is a diagram illustrating a configuration of a communication system 1c according to a third embodiment of the present invention.

FIG. 27 is a flowchart illustrating a specific example of processing of calculating a congestion time performed by a future congestion estimation unit 81c according to the third embodiment of the present invention.

FIG. 28 is a flowchart illustrating a numerical value example of the processing of calculating the congestion duration time performed by the future congestion estimation unit 81c according to the third embodiment of the present invention.

FIG. 29 is a flowchart illustrating a flow of processing of determining whether or not to perform the path switching by a switching determination unit 75c according to the third embodiment of the present invention.

FIG. 30 is a flowchart illustrating a flow of processing of determining whether or not to perform the path switching by the switching determination unit 75c according to the third embodiment of the present invention.

FIG. 31 is a diagram illustrating a configuration of a communication system 1d according to a fourth embodiment of the present invention.

FIG. 32 is a flowchart illustrating a specific example of processing of acquiring a congestion time performed by a future congestion estimation unit 81d according to the fourth embodiment of the present invention.

FIG. 33 is a diagram illustrating an example of congestion time information stored in a congestion time information storage unit 92 according to the fourth embodiment of the present invention.

FIG. 34 is a diagram illustrating a configuration of a communication system 1e according to a fifth embodiment of the present invention.

FIG. 35 is a flowchart illustrating a specific example of processing of calculating a congestion duration rate performed by a future congestion estimation unit 81e according to the fifth embodiment of the present invention.

FIG. 36 is a diagram illustrating a flow of processing performed by a switching instruction device 7e according to the fifth embodiment of the present invention.

FIG. 37 is a flowchart illustrating a flow of processing of determining whether or not to perform path switching by a switching determination unit 75e according to the fifth embodiment of the present invention.

### DESCRIPTION OF EMBODIMENTS

Hereinafter, some embodiments of the present invention will be described in detail with reference to the drawings. Note that, in each embodiment, components having the same function will be denoted by the same reference numerals, and repeated description of the function may be omitted.

Hereinafter, an example of a configuration of a communication system in the related art will be described first as a comparison target in order to make explanation of a configuration of a communication system according to the embodiment of the present invention easy to understand.

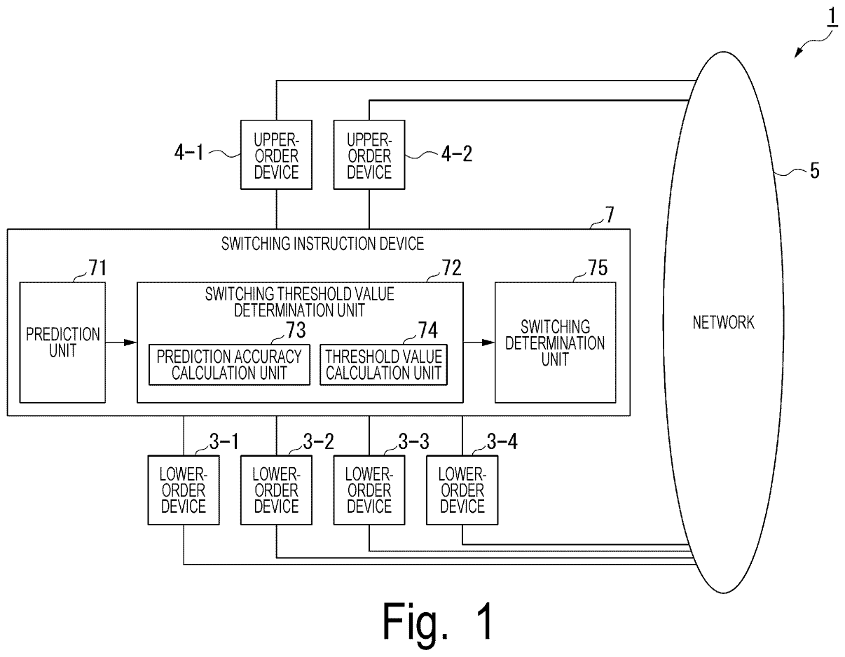

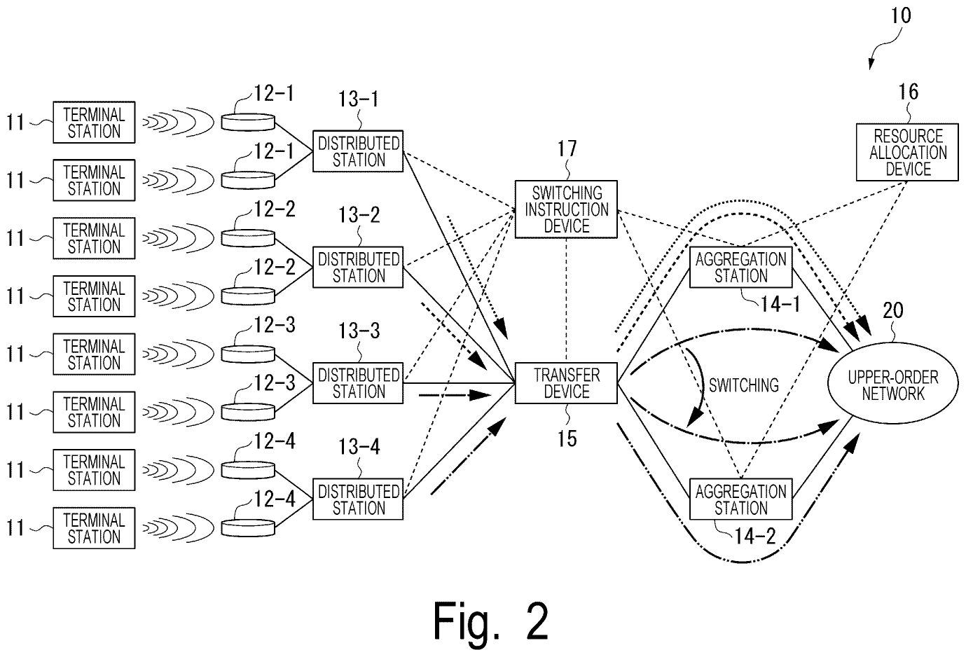

FIG. 1 is a diagram illustrating a configuration of a communication system 1 that is an example of a communication system in the related art. The communication system 1 includes a plurality of lower-order devices 3, a plurality of upper-order devices 4, and a switching instruction device 7. The lower-order devices 3 and the upper-order devices 4 are connected via a network 5. The network 5 is configured to include one or more transfer devices (not illustrated; a device corresponding to a transfer device 15, which will be described later and is illustrated in FIG. 2). In FIG. 1, four lower-order devices 3 are referred to as lower-order devices 3-1 to 3-4, and two upper-order devices 4 are referred to as upper-order devices 4-1 and 4-2. A direction from the lower-order devices 3 to the upper-order devices 4 is described as “uplink”, and a direction from the upper-order devices 4 to the lower-order devices 3 is described as “downlink”.

The lower-order devices 3 transmit uplink signals to the upper-order devices 4 that are connection destinations. The network 5 transfers the uplink signals to the upper-order devices 4 in accordance with communication paths between the lower-order devices 3 and the upper-order devices 4. Also, the upper-order devices 4 transmit downlink signals to the lower-order devices 3 that are connection destinations. The network 5 transfers the downlink signals to the lower-order devices 3 in accordance with the communication paths between the lower-order devices 3 and the upper-order devices 4. The switching instruction device 7 provides an instruction to switch the communication paths to each device such as the transfer device, for example.

The switching instruction device 7 predicts the traffic amount of some or all communication links (hereinafter, simply referred to as “links”) in the communication paths between the lower-order devices 3 and the upper-order devices 4 in advance using information such as the traffic amounts or the traffic allocation amounts (hereinafter, collectively referred to as “traffic amounts”) acquired from the lower-order devices 3 and the upper-order devices 4. The switching instruction device 7 determines, for each link, a switching threshold value on the basis of prediction accuracy of the traffic amount and a transmission ability of the link.

For example, a link rate can be used as the transmission ability of the link. The link rate is the maximum communication speed of the link. The switching threshold value is a threshold value used to determine whether or not occurrence of congestion requiring switching of the communication paths is predicted. Hereinafter, the switching of the communication path will also be referred to as “path switching”. The switching instruction device 7 determines the switching threshold value to be lower as the prediction accuracy is lower even at the same link rate, for example.

The switching instruction device 7 determines, for each link, whether or not congestion will occur using the information regarding the predicted traffic amount and the switching threshold value. In a case where occurrence of congestion is predicted in any of the links, the switching instruction device 7 determines to perform path switching for load distribution. The switching instruction device 7 provides an instruction to switch the communication paths such that at least some traffic transmitted by the link on which occurrence of congestion is predicted is transmitted by a link on which congestion is predicted not to occur. In this manner, it is possible to switch optimum communication paths in accordance with the prediction accuracy. In addition, a congestion delay of the link is reduced, and high utilization efficiency of a band is realized.

As illustrated in FIG. 1, the switching instruction device 7 includes a prediction unit 71, a switching threshold value determination unit 72, and a switching determination unit 75. The prediction unit 71 acquires prediction information used to predict the traffic amount of each link from each device. The prediction information is, for example, information such as the traffic amount observed in the device, the amount of allocation of the traffic to the device, the number of terminals connected to the device, and communication quality. The prediction unit 71 predicts a future traffic amount (hereinafter, referred to as a “future traffic amount”) for each link using the prediction information. Note that any existing technology can be used to predict the future traffic amount.

The switching threshold value determination unit 72 includes a prediction accuracy calculation unit 73 and a threshold value calculation unit 74. The prediction accuracy calculation unit 73 obtains the prediction accuracy for each link using a prediction result of the future traffic amount in the past and the actual traffic amount. The threshold value calculation unit 74 determines, for each link, the switching threshold value such that a rate to the link transmission ability (for example, a link rate) is lower as the prediction accuracy is lower.

The switching determination unit 75 determines, for each link, whether or not congestion will occur in advance using the predicted future traffic amount value and the switching threshold value. In a case where occurrence of congestion is predicted, the switching determination unit 75 determines to perform the path switching for load distribution. For example, the switching determination unit 75 determines to execute path switching from a link on which occurrence of congestion is predicted to a link with a low link utilization rate. The switching determination unit 75 provides an instruction for the path switching to each device.

Hereinafter, an exemplary case in which the communication system 1 is applied to a mobile communication system will be explained.

FIG. 2 is a diagram illustrating a configuration of a mobile communication system 10 that is an example of the communication system in the related art. The mobile communication system 10 is an example of the communication system 1. The mobile communication system 10 is, for example, a fifth generation mobile communication system (hereinafter, referred to as “5G”). The mobile communication system 10 includes a plurality of terminal stations 11, a plurality of antenna stations 12, a plurality of distributed stations 13, a plurality of aggregation stations 14, a transfer device 15, a switching instruction device 17, and a resource allocation device 16.

The terminal stations 11, the antenna stations 12, the distributed stations 13, and the aggregation stations 14 are user equipment (UE), radio units (RUs), distributed units (DUs), and central units (CUs) of 5G, respectively. The distributed stations 13 are an example of the lower-order devices 3, and the aggregation stations 14 are an example of the upper-order devices 4. The transfer device 15 is an example of a transfer device configuring the network 5. Note that the devices such as the switching instruction device 17, the transfer device 15, and the resource allocation device 16 may be configured as an integrated device.

The mobile communication system 10 is connected to an upper-order network 20. Here, M (M is an integer that is equal to or greater than one) distributed stations 13 will be described as distributed stations 13-1 to 13-M. Also, Km (Km is an integer that is equal to or greater than one) antenna stations 12 subordinate to the distributed station 13-m (m is an integer that is equal to or greater than one and equal to or less than M) will be described as an antenna station 12-m. Also, N (N is an integer that is equal to or greater than two) aggregation stations 14 will be described as aggregation stations 14-1 to 14-N. Therefore, the mobile communication system 10 illustrated in FIG. 2 is an example of a mobile communication system in which M=4, K1=2, K2=2, K3=2, K4=2, and N=2.

The terminal stations 11 transmit and receive radio signals to and from the antenna stations 12 using radio resources allocated by the distributed stations 13. The allocated radio resources include information indicating start timings and end timings of time sections in which transmission and reception of radio signals are allowed. The start timings and the end timings are represented by slots, for example. A slot is a scheduling unit of data transmission and reception in a radio frame. The allocated radio resources may further include information indicating a coding rate and a modulation scheme.

The antenna stations 12 receive uplink data from the terminal stations 11 by radio signals. The antenna station 12-m sets the received uplink data in an uplink signal and transmits the uplink signal to the distributed station 13-m via a wired interface. In addition, the antenna station 12-m receives a downlink signal from the distributed station 13-m via the wired interface. The antenna stations 12 transmit downlink data set in the received downlink signal and directed to the terminal stations 11 to the terminal stations 11 through radio signals.

The distributed station 13-m receives an uplink signal from each of the Km antenna stations 12-m. The uplink signal received by a distributed station 13-m includes the uplink data received by the antenna station 12-m from the subordinate terminal stations 11. The distributed stations 13 generate uplink signals obtained by aggregating the uplink data and transmit the generated uplink signals to the aggregation stations 14 that are connection destinations of the distributed stations 13 themselves. Also, the distributed stations 13 receive downlink signals in which downlink data directed to the subordinate terminal stations 11 is set from the aggregation stations 14 that are connection destinations of the distributed stations 13 themselves. The distributed station 13-m converts the received downlink signal into a downlink signal corresponding to a radio signal to be transmitted from each antenna station 12-m. The distributed station 13-m transmits the converted downlink signal to the antenna station 12-m corresponding to the downlink signal.

The aggregation stations 14 aggregate the uplink signals received from the subordinate distributed stations 13 and transfer the aggregated uplink signals to the upper-order network 20. Also, the aggregation stations 14 receive downlink signals in which downlink data directed to the terminal stations 11 are set from the upper-order network 20 and transfer the received downlink signals to the distributed stations 13 connected to the terminal stations 11 that are destinations.

The transfer device 15 is connected to the distributed stations 13, the aggregation stations 14, and the switching instruction device 17. The transfer device 15 transfers signals in accordance with the communication paths between the distributed stations 13 and the aggregation stations 14. In other words, the transfer device 15 transfers uplink signals received from the distributed stations 13 to the aggregation stations 14 that are destinations in accordance with the communication paths. Also, the transfer device 15 transfers downlink signals received from the aggregation stations 14 to the distributed stations 13 that are destinations in accordance with the communication paths. The transfer in accordance with the communication paths is instructed by the switching instruction device 17. The resource allocation device 16 manages resources of the aggregation stations 14.

The switching instruction device 17 is connected to the distributed stations 13, the aggregation stations 14, and the transfer device 15. Furthermore, the switching instruction device 17 may be connected to the resource allocation device 16. The switching instruction device 17 provides an instruction to switch the communication paths between the distributed stations 13 and the aggregation stations 14. In the mobile communication system 10, the communication paths between the distributed stations 13 and the aggregation stations 14 are determined by connection relationships between the distributed stations 13 and the aggregation stations 14. Thus, path switching between the distributed stations 13 and the aggregation stations 14 is performed by changing the aggregation stations 14 as connection destinations of the distributed stations 13 in the mobile communication system 10.

In addition, it is assumed here that the switching instruction device 17 in the mobile communication system 10 determines whether or not congestion will occur on the basis of an uplink traffic. Therefore, the traffic described here is assumed to mean the traffic of uplink signals unless otherwise particularly indicated.

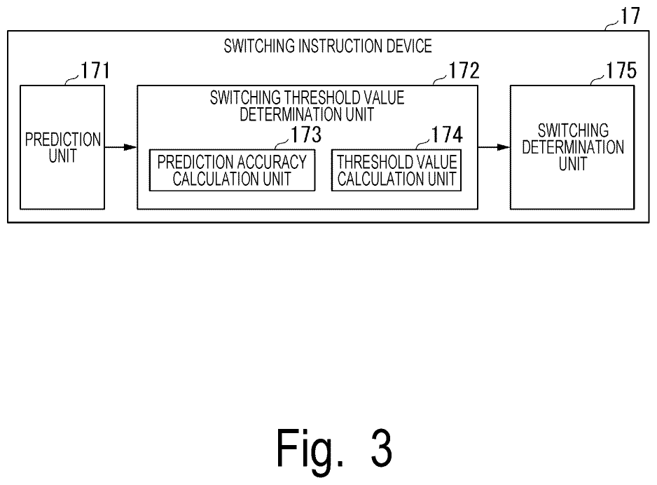

FIG. 3 is a block diagram illustrating a configuration of the switching instruction device 17 in the mobile communication system 10 that is an example of the communication system in the related art. The switching instruction device 17 includes a prediction unit 171, a switching threshold value determination unit 172, and a switching determination unit 175.

The prediction unit 171 receives radio information as prediction information from the distributed stations 13. The radio information indicates radio resources allocated to the terminal stations 11 subordinate to the distributed stations 13. The radio information is, for example, link control information (downlink control information: DCI). The prediction unit 171 calculates the future traffic amount of each distributed station 13 using the radio information from the distributed station 13.

Furthermore, the prediction unit 171 calculates the future traffic amount of each upper-order link on the basis of the connection relationships between the distributed stations 13 and the aggregation stations 14 and the future traffic amount of each distributed station 13. The upper-order link is a link between the aggregation stations 14 and the transfer device 15. The uplink traffic amount of the upper-order link between the aggregation station 14-n (n is an integer that is equal to or greater than one and equal to or less than N) and the transfer device 15 corresponds to the sum of the traffic amounts of the uplink signals received by the aggregation station 14-n from the subordinate distributed stations 13. The prediction unit 171 outputs the future traffic amount of the upper-order link to the switching threshold value determination unit 172 and the switching determination unit 175.

The switching threshold value determination unit 172 includes a prediction accuracy calculation unit 173 and a threshold value calculation unit 174. The prediction accuracy calculation unit 173 receives information indicating the actual traffic amounts from the distributed stations 13. The prediction accuracy calculation unit 173 calculates the actual amount of traffic that has actually flowed through each upper-order link on the basis of the actual traffic amounts from the distributed stations 13 and the connection relationships between the distributed stations 13 and the aggregation stations 14. The prediction accuracy calculation unit 173 calculates, for each upper-order link, the prediction accuracy on the basis of the future traffic amount predicted by the prediction unit 171 in the past and the actual traffic amount. The threshold value calculation unit 174 calculates, for each upper-order link, a switching threshold value on the basis of the link rate and the prediction accuracy. The threshold value calculation unit 174 outputs the switching threshold value of each upper-order link to the switching determination unit 175.

The switching determination unit 175 obtains, for each upper-order link, a predicted link utilization rate using the future traffic amount value received from the prediction unit 171 and the switching threshold value received from the threshold value calculation unit 174. In a case where there is an upper-order link that is determined to cause congestion due to a high predicted link utilization rate, the switching determination unit 175 determines to perform path switching by changing the aggregation stations 14 that are connection destinations of the distributed stations 13. In a case where it is determined that path switching is to be performed, the switching determination unit 175 provides an instruction for the path switching to each device.

Specifically, the switching determination unit 175 provides an instruction to release connection to the distributed stations 13 to the aggregation stations 14 that are connection destinations (hereinafter, referred to as “switching sources”) before the path switching and provides an instruction to establish connection to the distributed stations 13 to the aggregation stations 14 that are connection destinations (hereinafter, referred to as “switching destinations”) after the path switching. Furthermore, the switching instruction device 17 provides an instruction to perform path switching to the transfer device 15 such that signal transfer is performed through the communication paths after the path switching.

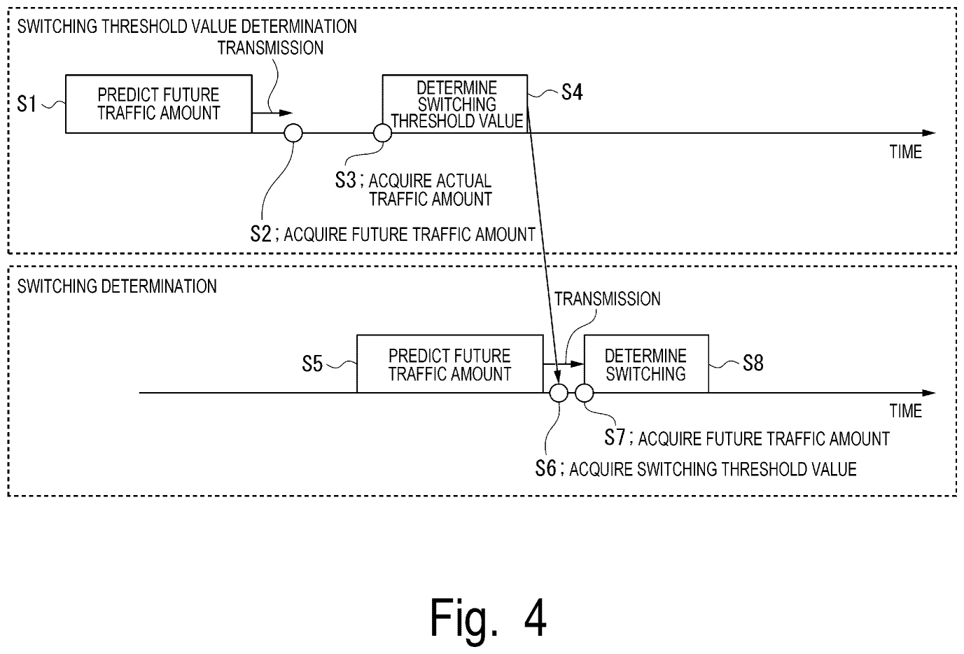

FIG. 4 is a diagram illustrating a flow of processing performed by the switching instruction device 17 in the mobile communication system 10 that is an example of the communication system in the related art. The prediction unit 171 predicts the future traffic amount of the upper-order link in a period D(a), for example (Step S1). The prediction accuracy calculation unit 173 acquires information indicating the future traffic amount predicted in Step S1 from the prediction unit 171 and stores the information until information indicating the actual traffic amount in the period D(a) is acquired (Step S2).

The prediction accuracy calculation unit 173 receives the information indicating the actual traffic amount in the period D(a) of the upper-order link (Step S3). The prediction accuracy calculation unit 173 calculates prediction accuracy on the basis of the stored future traffic amount in the period D(a) and the received actual traffic amount in the period D(a). The threshold value calculation unit 174 determines the switching threshold value on the basis of the link rate of the upper-order link and the prediction accuracy (Step S4). The threshold value calculation unit 174 outputs the determined switching threshold value to the switching determination unit 175.

On the other hand, the prediction unit 171 calculates the future traffic amount of the upper-order link in a period D(b) which is a period later than the period D(a) (Step S5). The switching determination unit 175 acquires the switching threshold value output in Step S4 from the threshold value calculation unit 174 (Step S6). Furthermore, the switching determination unit 175 acquires, from the prediction unit 171, information indicating the future traffic amount in the period D(b) calculated in Step S5 (Step S7). The switching determination unit 175 determines whether or not to perform the path switching on the basis of the switching threshold value and the future traffic amount value in the period D(b) (Step S8).

As described above, the future traffic amount acquired by the switching threshold value determination unit 172 is a traffic amount at a clock time earlier than the future traffic amount acquired by the switching determination unit 175.

As described above, the communication system 1 and the mobile communication system 10, which are examples of the conventional communication system, predict the future traffic amount of the upper-order link in the period D(a), and calculate the prediction accuracy on the basis of the future traffic amount and the actual traffic amount. The communication system 1 and the mobile communication system 10 determine the switching threshold value on the basis of the link rate of the upper-order link and the prediction accuracy. Then, the communication system 1 and the mobile communication system 10 predict the future traffic amount of the upper-order link in the period D(b) which is a period later than the period D(a) and determine whether or not to perform the path switching on the basis of the switching threshold value and the future traffic amount.

However, the path switching requires a certain time. Also, such a time required for the path switching is also one of factors of a communication delay. Therefore, the magnitude of a communication delay due to the path switching (hereinafter, also referred to as a “switching delay”) may be larger than the magnitude of a communication delay due to congestion (hereinafter, also referred to as a “congestion delay”) in a case where the path switching frequently occurs even if the future traffic amount of the upper-order link is predicted and occurrence of congestion is avoided. In this case, the communication delay as a whole is rather increased by performing the path switching. On the other hand, communication systems according to embodiments of the present invention explained below can reduce a communication delay due to congestion in consideration of a communication delay due to path switching.

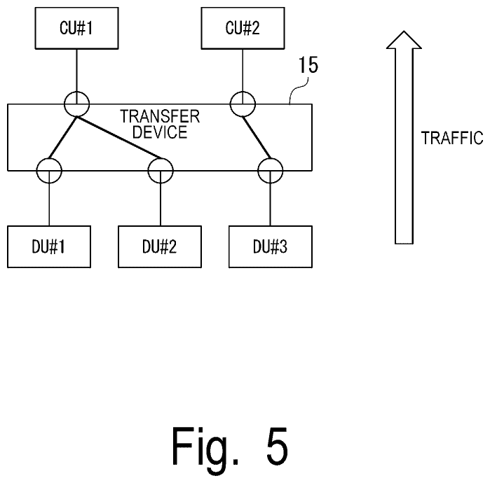

Hereinafter, a relationship between a communication delay associated with congestion and a communication delay associated with switching of communication paths will be described with reference to FIGS. 5 to 14.

FIG. 5 is a diagram illustrating an example of a communication system including a plurality of upper-order devices, a plurality of lower-order devices, and a transfer device 15. In FIG. 5, the upper-order devices are CUs, and the lower-order devices are DUs. FIG. 5 illustrates two CUs, namely CU #1 and CU #2, and three DUs, namely DU #1 to DU #3.

Here, uplink communication in which a traffic flows from the DUs to the CUs is assumed. In addition, a case is assumed here in which a link is fixedly established between the DU #1 and the CU #1 and a link is fixedly established between the DU #3 and the CU #2. Also, a case is assumed in which the DU #2 can selectively establish a link with either the CU #1 or the CU #2 by the transfer device 15 performing path switching. Note that FIG. 5 represents a state at a point before the path switching is performed and a link has been established between the DU #2 and the CU #1.

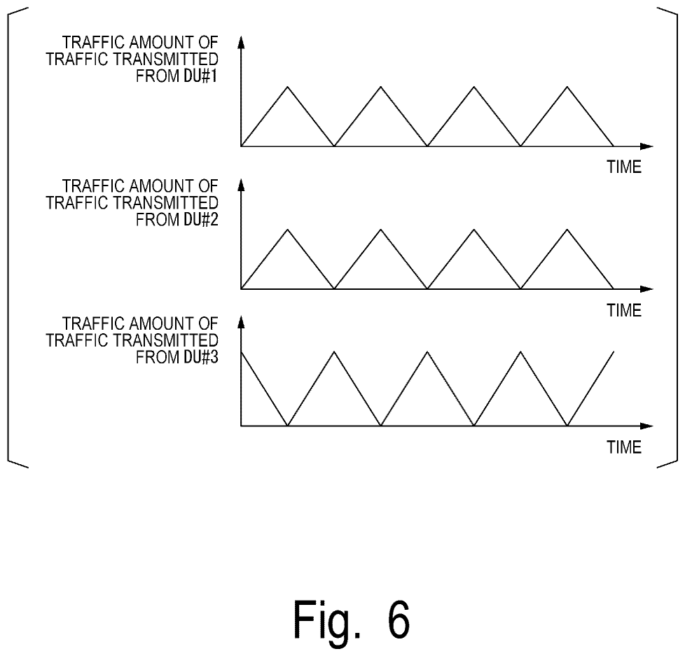

For example, a case is assumed in which a traffic as illustrated in FIG. 6 occurs in each DU in such a communication system. FIG. 6 is a diagram illustrating an example of a traffic amount of a traffic transmitted from each DU. In each of the three graphs illustrated in FIG. 6, the horizontal axis represents a time (or a clock time). In FIG. 6, the vertical axis of the graph in the upper section represents the traffic amount of the traffic transmitted from the DU #1, the vertical axis of the middle graph represents the traffic amount of the traffic transmitted from the DU #2, and the vertical axis of the lower graph represents the traffic amount of the traffic transmitted from the DU #3.

In the example illustrated in FIG. 6, transition of the traffic amount of the DU #1 for each time is similar to transition of the traffic amount of the DU #2 for each time. On the other hand, the transition of the traffic amount of the DU #1 for each time (and the transition of the traffic amount of the DU #2 for each time) and transition of the traffic amount of the DU #3 for each time are substantially opposite transitions.

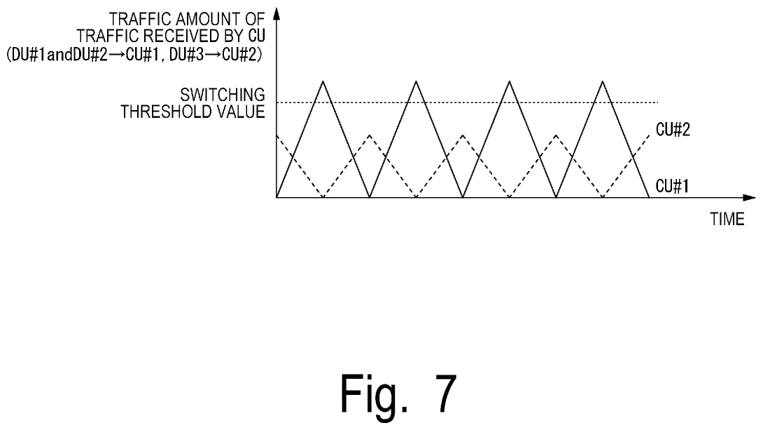

If the traffic amount of each DU is the traffic amount as illustrated in FIG. 6 described above for each link established between each CU and each DU as in FIG. 5 described above, the traffic amount of each CU is as illustrated in FIG. 7. FIG. 7 is a diagram illustrating an example of a traffic amount of a traffic received by each CU. In the graph illustrated in FIG. 7, the horizontal axis represents a time (or a clock time), and the vertical axis represents a traffic amount of a traffic received by each CU.

In the graph illustrated in FIG. 7, a solid line graph represents the traffic amount of the traffic received by the CU #1, and a broken line graph represents the traffic amount of the traffic received by the CU #2. Also, the switching threshold value is indicated by a dotted line in the graph in FIG. 7. As described above, the switching threshold value is a threshold value used to determine whether or not occurrence of congestion requiring path switching is predicted. For example, the switching threshold value is a value corresponding to the link speed of the upper-order network of the CU. In a case where the traffic amount value of the traffic received by the CU becomes greater than the switching threshold value, for example, it is determined that a congestion delay will occur in the situation, and path switching is performed.

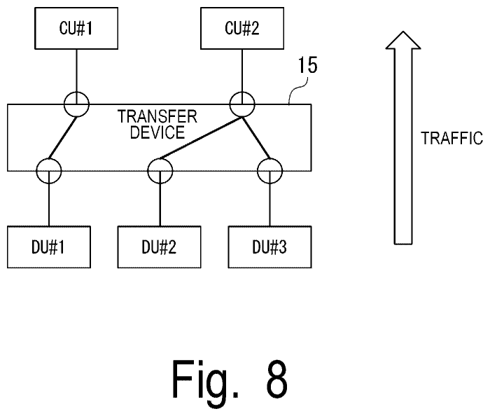

As illustrated in FIG. 7, the traffic amount of the CU #1 is the sum of the traffic amount of the DU #1 and the traffic amount of the DU #2, and a time zone in which the traffic amount exceeds the switching threshold value occurs. On the other hand, the traffic amount of the CU #2 is equivalent to the traffic amount of the DU #3, and a time zone in which the traffic amount exceeds the switching threshold value does not occur. In a case where the traffic amount of any of the CUs exceeds the switching threshold value (here, since the traffic amount of the CU #1 exceeds the switching threshold value as illustrated in FIG. 7), for example, the communication system performs path switching as illustrated in FIG. 8.

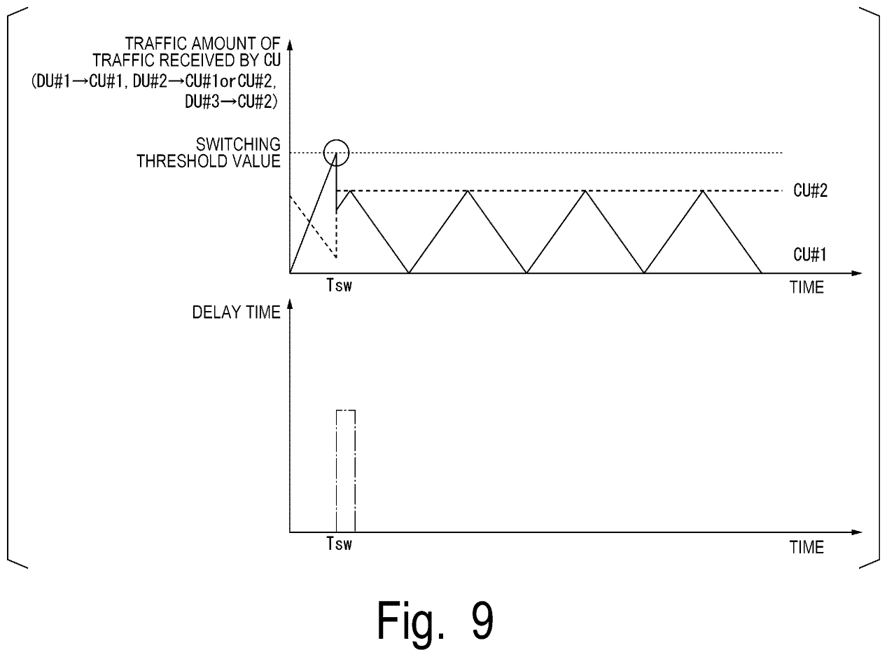

FIG. 8 is a diagram illustrating a link after path switching is performed in the communication system including the plurality of upper-order devices, the plurality of lower-order devices, and the transfer device 15. The DU #2 which has established a link with the CU #1 in FIG. 5 establishes a link with the CU #2 by path switching being performed. In this manner, the traffic amount of each CU illustrated in FIG. 7 changes as in the graph in the upper section illustrated in FIG. 9.

FIG. 9 is a diagram illustrating a change in traffic amount due to path switching and occurrence of a switching delay in the communication system including the plurality of upper-order devices, the plurality of lower-order devices, and the transfer device 15. The upper section of FIG. 9 is a graph indicating a change in traffic amount of the traffic received by each CU due to path switching. In the graph illustrated in the upper section of FIG. 9, the horizontal axis represents a time (or a clock time), and the vertical axis represents a traffic amount of a traffic received by each CU.

In FIG. 9, Tsw represents a timing (clock time) at which the path switching for switching a connection destination of the DU #2 from the CU #1 to the CU #2 is performed. In other words, the clock time Tsw is a timing (clock time) at which the path switching is performed from a state of the communication paths illustrated in FIG. 5 to a state of the communication paths illustrated in FIG. 8. In this manner, the traffic amount of the traffic received by the CU #1 decreases by the amount corresponding to the traffic amount of the traffic transmitted by the DU #2 at the clock time Tsw as illustrated in FIG. 9. On the contrary, the traffic amount of the traffic received by the CU #2 increases by the amount corresponding to the traffic amount of the traffic transmitted by the DU #2 at the clock time Tsw as illustrated in FIG. 9.

Unlike the traffic amount of the CU #1 in a case where the path switching illustrated in the graph of FIG. 7 described above is not performed, the traffic amount value of the CU #1 in a case where path switching illustrated in the graph in the upper section of FIG. 9 is performed does not exceed the switching threshold value. This is because the traffic of the DU #2 has been replaced from the CU #1 to the CU #2 and load distribution has been performed. In this manner, it is possible to prevent the traffic from exceeding the link speed of the upper-order network of the CUs by performing the path switching at a timing when the traffic amount value of any of the CUs exceeds the switching threshold value (or in advance) and to reduce occurrence of congestion. Then, it is possible to reduce or prevent a congestion delay by occurrence of congestion being reduced.

However, the path switching also requires a certain time as described above. In other words, although it is possible to prevent occurrence of a congestion delay which is a delay due to congestion by performing path switching, a switching delay which is a delay due to the path switching occurs. The lower section of FIG. 9 is a graph illustrating occurrence of a switching delay caused by the path switching. In the graph illustrated in the lower section of FIG. 9, the horizontal axis represents a time (or a clock time), and the vertical axis represents the length of a delay time of the switching delay. Also, a one-dotted chain line of the graph illustrated in the lower section of FIG. 9 represents the length of the delay time due to the switching delay.

Typically, the switching delay is caused by buffering being performed with packet transmission from each DU to the transfer device 15 paused to prevent packets from being lost during path switching, for example. A switching delay of about 1 [milliseconds (ms)] occurs in a case where the transfer device 15 is an optical switch, for example. Therefore, the switching delay may be above the avoided congestion delay, and the communication delay may rather increase in a case where the path switching frequently occurs even if path switching is performed to avoid the congestion delay.

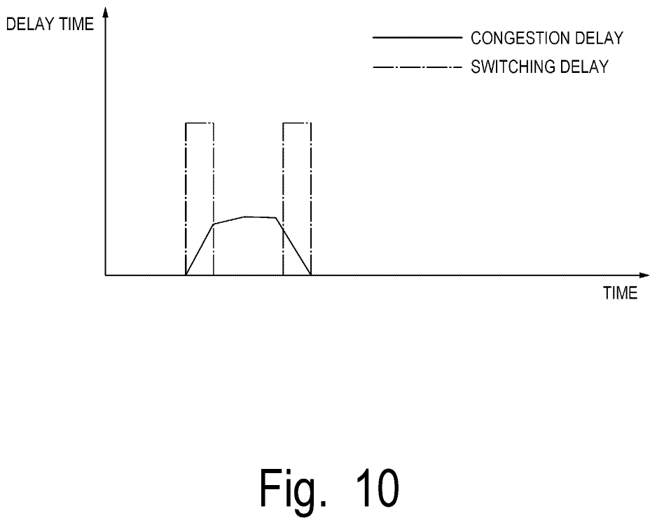

FIG. 10 is a diagram illustrating an example of a relationship between the congestion delay and the switching delay. In the graph illustrated in FIG. 10, the horizontal axis represents a time (or a clock time), and the vertical axis represents the length of a delay time. In addition, the solid line graph represents a congestion delay, and the one-dotted chain line represents a switching delay in FIG. 10. In other words, the solid line graph represents a communication delay (that is, a congestion delay) in a case where path switching is not performed, and the one-dotted chain line graph represents a delay (that is, a switching delay) of communication in a case where path switching is performed, in FIG. 10.

FIG. 10 illustrates, as an example, a case where it is necessary to perform path switching twice when path switching is performed in order to prevent a congestion delay. In the case of the delay time as illustrated in FIG. 10, a total value of the delay times due to the two switching delays is above the delay time due to the congestion delay. In this manner, the communication delay as a whole may be rather reduced by not performing the path switching even in a case where the congestion delay occurs.

Hereinafter, in what kind of case the communication delay can be further reduced by performing the path switching and in what kind of case the communication delay can be further reduced by not performing the path switching will be considered.

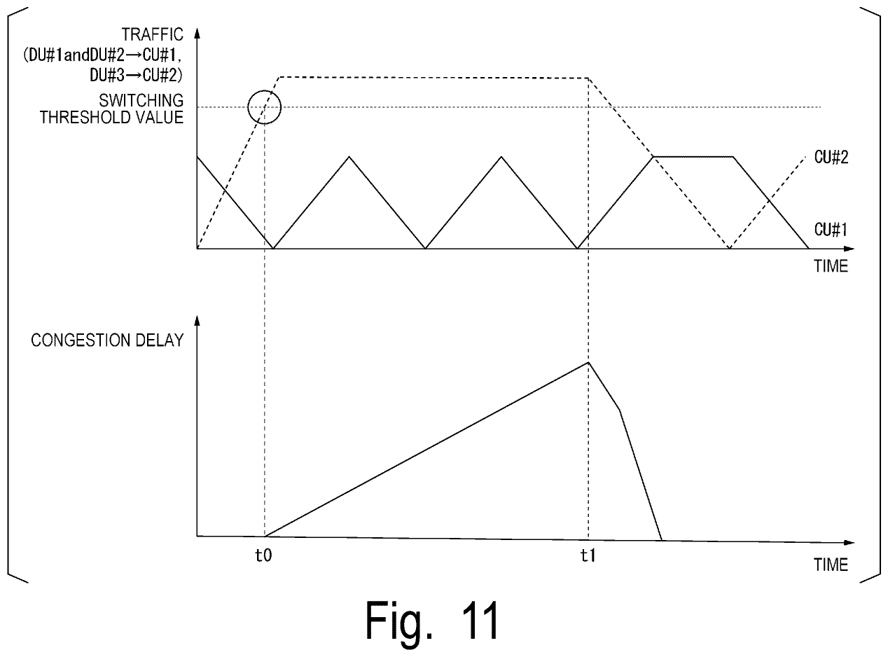

FIG. 11 is a diagram for explaining the magnitude of a congestion delay in a case where the path switching is not performed when a duration time of a congestion state is relatively long. The upper section of FIG. 11 is a diagram illustrating an example of transition of a traffic received by each CU. In the graph illustrated in the upper section of FIG. 11, the horizontal axis represents a time (or a clock time), and the vertical axis represents a traffic amount of a traffic received by each CU. In the graph illustrated in FIG. 11, a solid line graph represents the traffic amount of the traffic received by the CU #1, and a broken line graph represents the traffic amount of the traffic received by the CU #2. Also, the switching threshold value is indicated by a dotted line in the graph in FIG. 11.

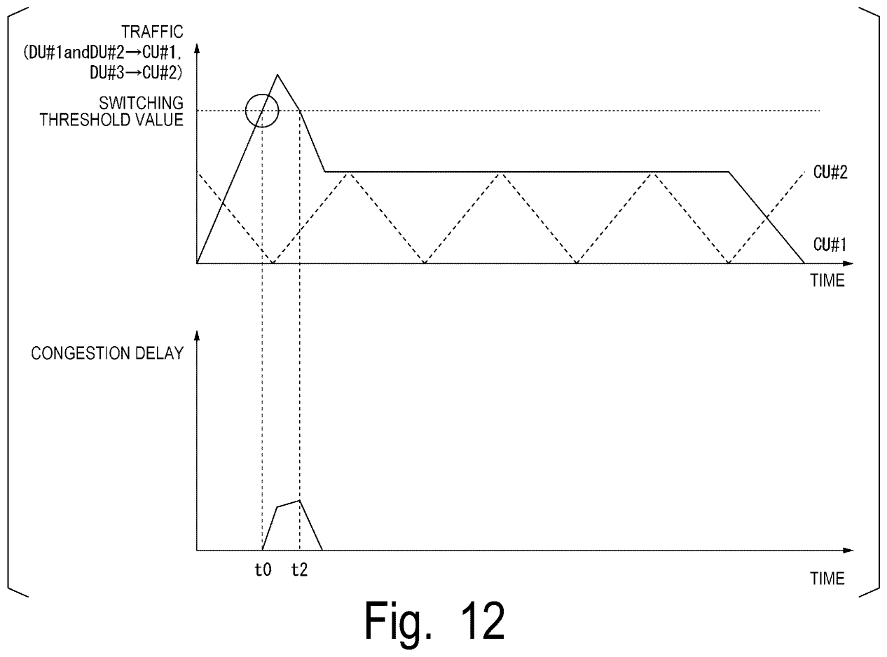

In the example illustrated in FIG. 11, the traffic amount of the traffic received by the CU #1 does not exceed the switching threshold value. On the other hand, the traffic amount of the traffic received by the CU #2 exceeds the switching threshold value in a time from a clock time t0 to a clock time t1. The duration time of the congestion state from the clock time t0 to the clock time t1 (hereinafter, also referred to as a “congestion duration time”) is a time that is relatively longer than the congestion duration time from the clock time t0 to a clock time t2 in the example illustrated in FIG. 12, which will be described later.

The lower section of FIG. 11 is a diagram illustrating the magnitude of a congestion delay in a case where congestion indicated by the graph in the upper section of FIG. 11 occurs. In the graph illustrated in the lower section of FIG. 11, the horizontal axis represents a time (or a clock time), and the vertical axis represents the magnitude of a delay time of the congestion delay. As illustrated in the graph in the lower section of FIG. 11, the magnitude of the congestion delay becomes relatively large when path switching is not performed in a case where the congestion duration time is relatively long.

FIG. 12 is a diagram for explaining the magnitude of the congestion delay in a case where the path switching is not performed when the duration time of the congestion state is relatively short. The upper section of FIG. 12 is a diagram illustrating an example of transition of a traffic received by each CU. In the graph illustrated in the upper section of FIG. 12, the horizontal axis represents a time (or a clock time), and the vertical axis represents a traffic amount of a traffic received by each CU. In the graph illustrated in the upper section of FIG. 12, a solid line graph represents the traffic amount of the traffic received by the CU #1, and a broken line graph represents the traffic amount of the traffic received by the CU #2. Also, the switching threshold value is indicated by a dotted line in the graph in FIG. 12.

In the example illustrated in the upper section of FIG. 12, the traffic amount of the traffic received by the CU #2 does not exceed the switching threshold value. On the other hand, the traffic amount of the traffic received by the CU #1 exceeds the switching threshold value in a time from the clock time t0 to the clock time t2. The congestion duration time from the clock time t0 to the clock time t2 is a time that is relatively shorter than the congestion duration time from the clock time t0 to the clock time t1 in the example illustrated in FIG. 11 described above.

The lower section of FIG. 12 is a diagram illustrating the magnitude of a congestion delay in a case where congestion indicated by the graph in the upper section of FIG. 12 occurs. In the graph illustrated in the lower section of FIG. 12, the horizontal axis represents a time (or a clock time), and the vertical axis represents the magnitude of the congestion delay (for example, the length of a delay time due to the congestion delay). As illustrated in the graph in the lower section of FIG. 12, the magnitude of the congestion delay does not become relatively large (as compared with FIG. 11 described above) even if the path switching is not performed in a case where the congestion duration time is relatively short.

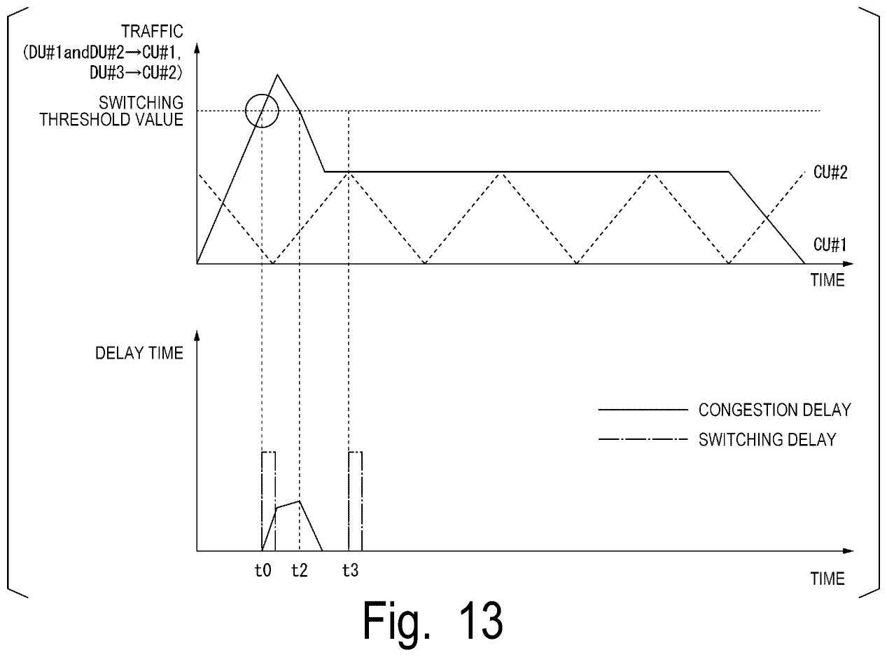

FIG. 13 is a diagram for explaining the magnitude of the switching delay in a case where path switching is performed when the duration time of the congestion state is relatively short. The upper section of FIG. 13 is a diagram illustrating an example of transition of a traffic received by each CU and is the same diagram as the diagram in the upper section of FIG. 12.

The lower section of FIG. 13 is a diagram illustrating the magnitude of a switching delay occurring in a case where path switching is performed when the congestion indicated by the graph in the upper section of FIG. 12 occurs. In addition, the magnitude of the congestion delay indicated by the graph in the lower section of FIG. 12 is also illustrated by a solid line as a comparison target in the graph in the lower section of FIG. 13. In the graph illustrated in the lower section of FIG. 13, the horizontal axis represents a time (or a clock time), and the vertical axis represents the magnitude of a delay (for example, the length of the delay time due to the switching delay and the congestion delay).

As illustrated in the graph in the lower section of FIG. 13, the magnitude of the congestion delay does not become relatively large (as indicated by the solid line graph) even when path switching is not performed in a case where the duration time of congestion is relatively short. On the other hand, the path switching may frequently occur when the path switching is performed in a case where the duration time of congestion is relatively short. In the example illustrated in the lower part of FIG. 13, the path switching occurs at two timings, namely the clock time t0 and a clock time t3. Note that the interval between the clock time t0 and the clock time t3 is an interval that is relatively shorter as compared with the interval between the clock time t0 and the clock time t1 illustrated in FIG. 11 described above.

In a case where the delay time as indicated by the graph in the lower section of FIG. 13 occurs, the total value of the delay times of the switching delay (indicated by the graph of the one-dotted chain line) due to the path switching performed twice is above the delay time due to the congestion delay (indicated by the graph of the solid line). In such a case, an increase in communication delay can be rather curbed by not performing the path switching even if congestion occurs.

The communication systems in the embodiments of the present invention explained below basically estimate the congestion duration time every time occurrence of congestion is predicted, and determine whether the congestion duration time is a relatively short time or a relatively long time. Alternatively, the communication systems in the embodiments of the present invention explained below basically estimate a congestion duration rate every time occurrence of congestion is predicted, and determine whether the congestion duration rate is relatively low or relatively high.

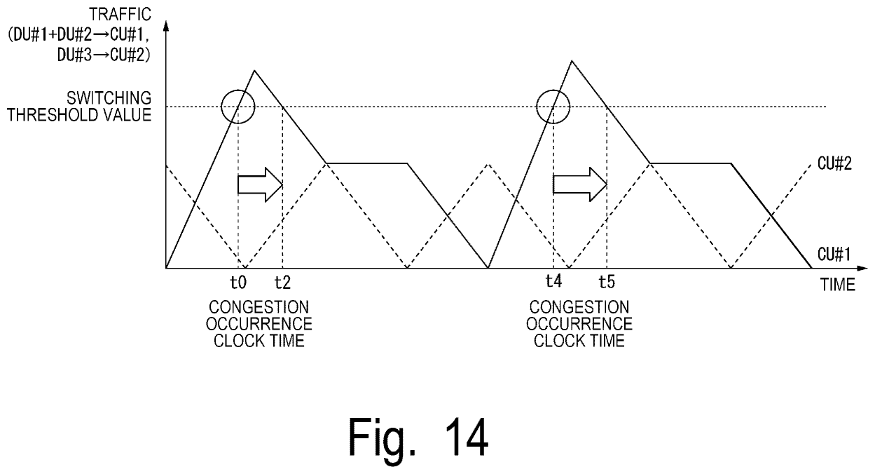

FIG. 14 is a diagram illustrating an example of a timing for determining a duration time of the congestion state. In the graph illustrated in FIG. 14, the horizontal axis represents a time (or a clock time), and the vertical axis represents a traffic amount of traffic received by each CU. In the graph illustrated in FIG. 14, a solid line graph represents the traffic amount of the traffic received by the CU #1, and a broken line graph represents the traffic amount of the traffic received by the CU #2. Also, the switching threshold value is indicated by a dotted line in the graph in FIG. 14.

In the example illustrated in FIG. 14, the traffic amount of the traffic received by the CU #2 does not exceed the switching threshold value. On the other hand, the traffic amount of the traffic received by the CU #1 exceeds the switching threshold value in a time from the clock time t0 to the clock time t2 and a time from a clock time t4 and a clock time t5.

The communication systems in the embodiments of the present invention estimate each of the predicted congestion duration time from the clock time t0 to the clock time t2 and the predicted congestion duration time from the clock time t4 to the clock time t5, and determine whether these congestion duration times are relatively short times or relatively long times. For example, the communication systems in the embodiments of the present invention determine that the plurality of congestion duration times from the clock time t0 to the clock time t2 are short and do not perform path switching. For example, the communication systems in the embodiments of the present invention determine that the plurality of congestion duration times from the clock time t4 to the clock time t5 are long and perform path switching.

The communication systems in the embodiments of the present invention explained below basically include a configuration to perform control to estimate the congestion duration time, and not to perform path switching in a case where the duration time is estimated to be a relatively short time, or to perform the path switching in a case where the duration time is estimated to be a relatively long time. In other words, the communication systems in the embodiments of the present invention include a configuration of preventing unnecessary path switching from being executed by not performing the path switching in a case where congestion, occurrence of which is predicted, is determined to be temporary congestion that does not require path switching. The communication systems according to the embodiments of the present invention can reduce the congestion delay while considering an increase in switching delay due to path switching and can thus more effectively reduce a communication delay by including such a configuration.

Although the communication systems in the embodiments of the present invention include a configuration to estimate a level of the congestion duration time, methods of estimating the congestion duration time differ depending on traffic patterns. The traffic pattern described here includes various traffic patterns such as a traffic pattern of a video, a discontinuous traffic pattern, and an unpredictable traffic pattern, for example.

In an embodiment of the present invention explained below, a case in which a communication system processes a video traffic is assumed as an example. Typically, a video traffic pattern is a traffic pattern in which an average traffic amount per terminal (hereinafter, also referred to as a “UE”.) is constant but a transmission rate changes depending on a wireless environment (for example, radio wave intensity). Note that the terminal (not illustrated) described here is a terminal device corresponding to the terminal station 11 in FIG. 2.

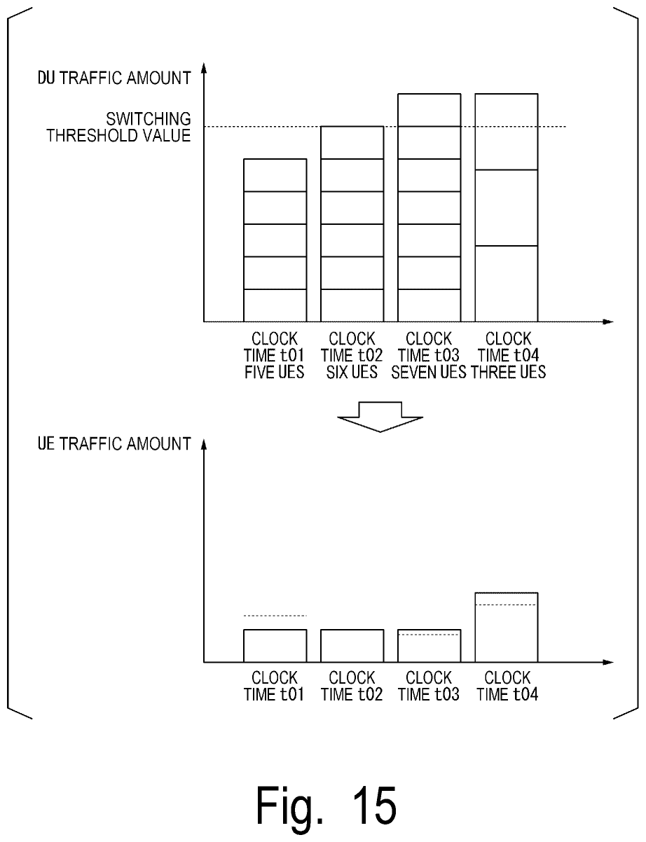

FIG. 15 is a diagram illustrating an example of a relationship between a traffic amount of a DU and a traffic amount per UE. In the embodiment of the present invention explained below, a case is assumed in which the traffic amount obtained by dividing the traffic amount of DU by the number of terminals (the number of UEs) is the traffic amount per UE. Note that the traffic amount per UE changes depending on a communication connection status such as a wireless environment, for example. Note that it is assumed that a video traffic from the UE is created at a constant transmission rate by a video traffic application (for example, a codec or the like) for each UE. Then, a case is assumed in which the transmission rate of the video traffic from the UE varies by the video traffic being transmitted in accordance with the wireless environment or the like.

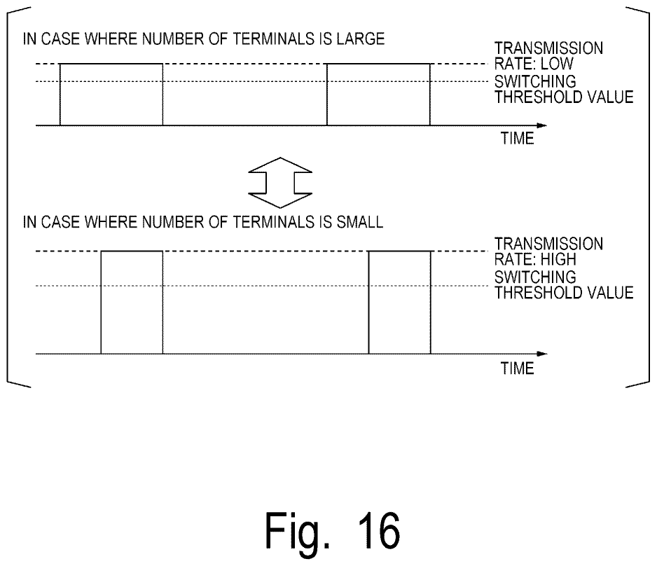

FIG. 16 is a diagram illustrating an example of a relationship among the number of terminals, a transmission rate, and a communication duration time. In the embodiment of the present invention explained below, a case is assumed in which the amount of traffic transmitted by one UE in one-time transmission is determined in advance. For example, a case is assumed in which the traffic pattern is a traffic pattern of a video traffic as described above and a total of 10 [MB] is transmitted at a cycle of 17 [ms]. In addition, an on-off model in which a traffic is transmitted in an on period at a constant rate is assumed for the traffic.

As illustrated in the upper section of FIG. 16, the transmission rate per terminal becomes low, and the amount of traffic per terminal becomes small, in a case where the number of terminals (the number of UEs) is large, for example. In this case, since the amount of traffic transmitted by one terminal in one-time transmission is determined in advance as described above, the transmission time (communication duration time) from the terminal becomes long. In such a case, the communication system in the embodiment explained below determines that there is a high possibility that the traffic is transmitted from the terminal even at the next clock time. Then, the communication system determines to perform path switching for load distribution.

As illustrated in the lower section of FIG. 16, the transmission rate per terminal becomes high, and the amount of traffic per terminal becomes large, in a case where the number of terminals (the number of UEs) is small, for example. In this case, since the amount of traffic transmitted by one terminal in one-time transmission is determined in advance as described above, the transmission time (communication duration time) from the terminal becomes short. In such a case, the communication system in the embodiment explained below determines that there is a low possibility that the traffic is transmitted from the terminal even at the next clock time. Then, the communication system determines not to perform path switching for load distribution.

As described above, the traffic amount and the transmission time are in an inversely proportional relationship when only one terminal is observed in the embodiment explained below. Then, the communication system in the embodiment explained below performs control to perform path switching for load distribution in a case where the number of terminals is large and congestion has occurred, and not to perform path switching for load distribution in a case where the number of terminals is small and congestion has occurred, for example.

### First Embodiment

Hereinafter, a communication system 1a according to a first embodiment of the present invention will be described with reference to drawings.

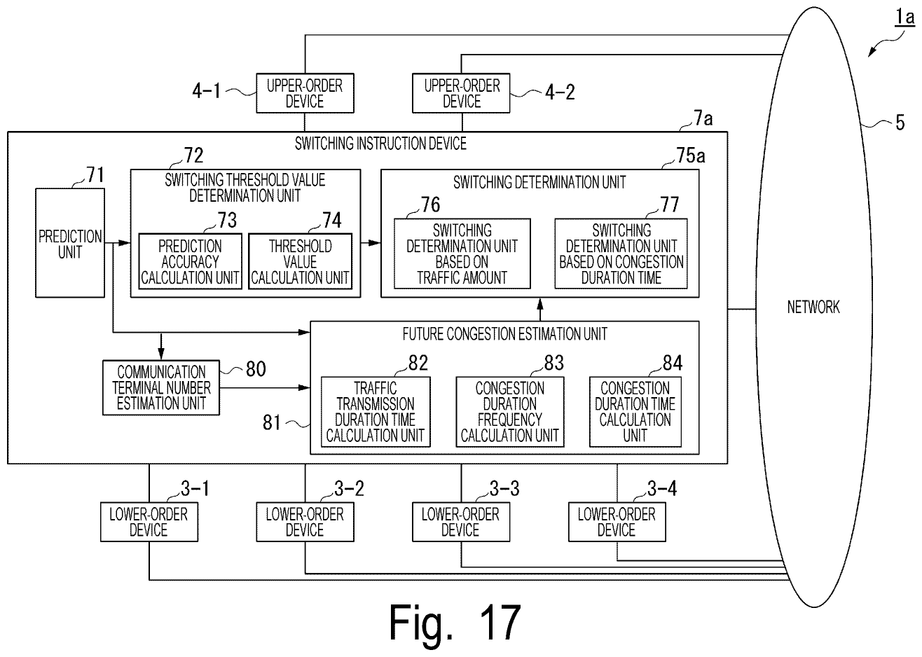

FIG. 17 is a diagram illustrating a configuration of the communication system 1a according to the first embodiment of the present invention. The communication system 1a includes a plurality of lower-order devices 3, a plurality of upper-order devices 4, and a switching instruction device 7a. The lower-order devices 3 and the upper-order devices 4 are connected via a network 5. The network 5 is configured to include one or more transfer devices (not illustrated; a device corresponding to a transfer device 15, which is illustrated in FIG. 2 described above). In FIG. 17, four lower-order devices 3 are referred to as lower-order devices 3-1 to 3-4, and two upper-order devices 4 are referred to as upper-order devices 4-1 and 4-2.

The lower-order devices 3 transmit uplink signals to the upper-order devices 4 that are connection destinations. The network 5 transfers the uplink signals to the upper-order devices 4 in accordance with communication paths between the lower-order devices 3 and the upper-order devices 4. Also, the upper-order devices 4 transmit downlink signals to the lower-order devices 3 that are connection destinations. The network 5 transfers the downlink signals to the lower-order devices 3 in accordance with the communication paths between the lower-order devices 3 and the upper-order devices 4. The switching instruction device 7a provides an instruction to switch the communication paths (path switching) to each device.

The switching instruction device 7a predicts the traffic amount of some or all of links in the communication paths between the lower-order devices 3 and the upper-order devices 4 in advance using information such as the traffic amounts (the traffic amounts, the traffic allocation amounts, and the like) acquired from the lower-order devices 3 and the upper-order devices 4. The switching instruction device 7a determines, for each link, a switching threshold value on the basis of prediction accuracy of the traffic amount and a transmission ability of the link.

For example, a link rate can be used as the transmission ability of the link. The link rate is the maximum communication speed of the link. The switching threshold value is a threshold value used to determine whether or not occurrence of congestion requiring switching of the communication paths (path switching) is predicted. The switching instruction device 7a determines the switching threshold value to be lower as the prediction accuracy is lower even at the same link rate.

The switching instruction device 7a determines, for each link, whether or not congestion will occur using the information regarding the predicted traffic amount and the switching threshold value. In a case where occurrence of congestion is predicted in any of the links, the switching instruction device 7a predicts a congestion duration time. In a case where the predicted congestion duration time is relatively long, the switching instruction device 7a determines to perform path switching for load distribution. In a case where the predicted congestion duration time is relatively short, the switching instruction device 7a determines not to perform path switching. This is because there is a probability that the sum of the switching delays may be above the congestion delay in a case where path switching frequently occurs as described above and the magnitude of the congestion delay is not relatively large (as compared with that in FIG. 11 described above) even if the path switching is not performed in the case where the congestion duration time is relatively short as illustrated in FIG. 12 described above.

In a case where it is determined to perform the path switching for load distribution, the switching instruction device 7a provides an instruction to switch the communication paths such that at least a part of the traffic transmitted by the link on which occurrence of congestion is predicted is transmitted by a link on which congestion is predicted not occur. Specifically, the switching instruction device 7a provides an instruction to perform the path switching to devices such as the transfer device 15 and the like of the network 5. In this manner, it is possible to achieve optimum communication path switching in accordance with prediction accuracy that curbs a congestion delay while considering a switching delay. In addition, a congestion delay of the link is reduced, and high utilization efficiency of a band is realized.

As illustrated in FIG. 17, the switching instruction device 7a includes a prediction unit 71, a switching threshold value determination unit 72, a switching determination unit 75a, a communication terminal number estimation unit 80, and a future congestion estimation unit 81. The prediction unit 71 acquires prediction information used to predict the traffic amount of each link from each device. The prediction information is, for example, information such as the traffic amount observed in the device, the amount of allocation of the traffic to the device, the number of terminals connected to the device, and communication quality.

The prediction unit 71 predicts a future traffic amount for each link using the prediction information. Note that any existing technology can be used to predict the future traffic amount. The prediction unit 71 outputs information indicating the calculated future traffic amount for each link to the switching threshold value determination unit 72, the communication terminal number estimation unit 80, and the future congestion estimation unit 81.

The switching threshold value determination unit 72 includes a prediction accuracy calculation unit 73 and a threshold value calculation unit 74. The prediction accuracy calculation unit 73 receives information indicating the actual traffic amounts from the lower-order devices 3. The prediction accuracy calculation unit 73 calculates the actual amount of traffic that has actually flowed through each upper-order link on the basis of the actual traffic amounts from the lower-order devices 3 and connection relationships between the lower-order devices 3 and the upper-order devices 4. The prediction accuracy calculation unit 73 calculates, for each upper-order link, the prediction accuracy on the basis of the future traffic amount predicted by the prediction unit 71 in the past and the actual traffic amount. The threshold value calculation unit 74 determines, for each upper-order link, the switching threshold value such that a rate to the link transmission ability (for example, a link rate) is lower as the prediction accuracy is lower. The threshold value calculation unit 74 outputs the switching threshold value of each upper-order link to the switching determination unit 75a.

The switching determination unit 75a includes a switching determination unit 76 based on the traffic amount and a switching determination unit 77 based on the congestion duration time. The switching determination unit 76 based on the traffic amount determines, for each link, whether or not congestion will occur in advance using information regarding the predicted future traffic amount value and the switching threshold value of the upper-order link. In a case where occurrence of congestion is predicted, the switching determination unit 76 based on the traffic amount determines to perform the path switching for load distribution.

However, in a case where the switching determination unit 77 based on the congestion duration time, which will be described later, determines not to perform the path switching even if the switching determination unit 76 based on the traffic amount determines to perform the path switching, the path switching is not performed. The switching determination unit 76 based on the traffic amount outputs information indicating that it is determined that the path switching for load distribution is to be performed to the switching determination unit 77 based on the congestion duration time.

In a case where the switching determination unit 76 based on the traffic amount determines to perform the path switching, the switching determination unit 77 based on the congestion duration time determines whether or not to perform the path switching for load distribution on the basis of the congestion duration time estimated by the future congestion estimation unit 81, which will be described later. In a case where the congestion duration time is relatively long, for example, the switching determination unit 77 based on the congestion duration time determines to execute the path switching from a link on which occurrence of congestion is predicted to a link with a low link utilization rate. In addition, in a case where the congestion duration time is relatively short, the switching determination unit 77 based on the congestion duration time determines not to execute the path switching.

In a case where a product of the congestion time and the congestion duration time is longer than the sum of the switching times, for example, the switching determination unit 77 based on the congestion duration time determines to execute the path switching from the link on which occurrence of congestion is predicted to a link with a lower link utilization rate. In a case where it is determined perform the path switching, the switching determination unit 75a provides an instruction to perform processing for the path switching to each device.

The communication terminal number estimation unit 80 calculates the number of terminals (UE) (hereinafter, referred to as a “number of terminals in communication”) that are performing communication with each lower-order device 3 (each DU, for example). For example, the communication terminal number estimation unit 80 specifies a connection relationship between the UEs and the CUs on the basis of UE IDs (for example, C-RNTI (3GPP (registered trademark) TS38.300)) which is radio information from the UEs and a gNB-CU IDs (3GPP (registered trademark) TS38.401). Then, the communication terminal number estimation unit 80 counts the number of terminals that are performing communication for each CU. The communication terminal number estimation unit 80 updates the number of communication terminals for each CU for each transmission interval (for example, a slot length) of the traffic. The communication terminal number estimation unit 80 outputs information indicating the calculated number of terminals in communication to the future congestion estimation unit 81.

Note that the communication terminal number estimation unit 80 may count the number of terminals in communication for each DU by using a gNB-DU ID (3GPP (registered trademark) TS38.401). Note that the communication terminal number estimation unit 80 may acquire the number of terminals in communication from Number of active UEs, which is radio information transmitted from each lower-order device 3.

The future congestion estimation unit 81 is configured to include a traffic transmission duration time calculation unit 82, a congestion duration frequency calculation unit 83, and a congestion duration time calculation unit 84. The traffic transmission duration time calculation unit 82 calculates the transmission duration time of the traffic per terminal on the basis of the future traffic amount for each link predicted by the prediction unit 71, the average traffic amount, and the number of terminals in communication estimated by the communication terminal number estimation unit 80.

The congestion duration frequency calculation unit 83 calculates an occurrence frequency (or an occurrence rate) for each congestion duration time on the basis of the congestion time and the transmission interval of the traffic. The congestion duration time calculation unit 84 estimates a future (for example, several ms ahead) congestion duration time on the basis of the congestion duration time and the occurrence frequency (or the occurrence rate) for each congestion duration time calculated by the congestion duration frequency calculation unit 83. The congestion duration time calculation unit 84 outputs the calculated future congestion duration time to the switching determination unit 75a.

Hereinafter, processing of calculating the congestion duration time performed by the future congestion estimation unit 81 and processing of controlling the path switching performed by the switching determination unit 75a will be further specifically described.

As described above, the future congestion estimation unit 81 includes a traffic transmission duration time calculation unit 82, a congestion duration frequency calculation unit 83, and a congestion duration time calculation unit 84 as illustrated in FIG. 17. Also, the switching determination unit 75a includes a switching determination unit 76 based on the traffic amount and a switching determination unit 77 based on the congestion duration time.

Hereinafter, an average rate per terminal is defined as m, a transmission cycle of traffic is defined as T, the number of terminals in communication is defined as n, a future traffic amount is defined as PT, and a transmission interval of the traffic is defined as int.

The traffic transmission duration time calculation unit 82 calculates the transmission duration time of the traffic on the basis of the average rate per terminal, the transmission cycle of the traffic, the number of terminals in communication, the future traffic amount, and the transmission interval of the traffic. The congestion duration frequency calculation unit 83 calculates the occurrence frequency for each congestion duration time on the basis of the transmission cycle of the traffic, the number of terminals in communication, and the transmission interval of the traffic. The congestion duration time calculation unit 84 calculates the predicted congestion duration time on the basis of the occurrence frequency for each congestion duration time and outputs the congestion duration time to the switching determination unit 75a.

The switching determination unit 76 based on the traffic amount predicts for each link, whether or not congestion will occur in advance using information regarding the predicted future traffic amount value and the switching threshold value of the upper-order link and determines whether or not to perform the path switching. In a case where it is determined not to be necessary to perform the path switching, the switching determination unit 76 based on the traffic amount ends the series of processing related to the path switching. Moreover, in a case where the switching determination unit 76 based on the traffic amount determines that it is necessary to perform the path switching, the switching determination unit 77 based on the congestion duration time further determines whether or not to perform the path switching. The switching determination unit 77 based on the congestion duration time calculates a congestion delay on the basis of the future traffic amount and the switching threshold value. The switching determination unit 77 based on the congestion duration time determines whether or not to perform the path switching in consideration of a state of congestion of several ms ahead, for example, on the basis of the calculated congestion delay and congestion duration time.

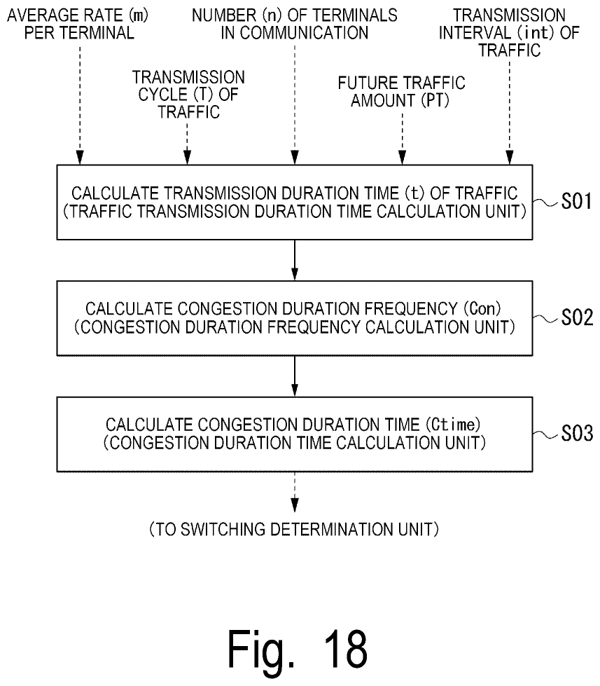

Hereinafter, the processing of calculating the congestion duration time performed by the future congestion estimation unit 81 will be described in more detail. FIG. 18 is a flowchart illustrating a flow of processing of calculating a congestion duration time performed by the future congestion estimation unit 81 according to the first embodiment of the present invention.

The traffic transmission duration time calculation unit 82 calculates a transmission duration time (t) of the traffic on the basis of an average rate (m) per terminal, a transmission cycle (T) of the traffic, the number (n) of terminals in communication, a future traffic amount (PT), and a transmission interval (int) of the traffic (Step S01). Here, the congestion duration time differs depending on the duration time of the traffic of one terminal and the number (n) of terminals in communication. If the congestion duration time is defined as t_x, a congestion duration time (t_X) is defined at an arbitrary interval between the slot length to the transmission duration time (t) of the traffic.

The arbitrary interval depends on, for example, a slot length or a prediction interval. When the slot length is 0.25 [ms] and the transmission duration time (t) of the traffic is 2 [ms], for example, the congestion duration time (t_x) may be t_x=0.25, 0.5, 0.75, 1, 1.25, 1.5, 1.75, 2. Furthermore, when the slot length is 0.25 [ms], the transmission duration time (t) of the traffic is 2 [ms], and the prediction interval is 1 [ms], the congestion duration time (t_x) may be t_x=1, 2.

The congestion duration frequency calculation unit 83 calculates each occurrence frequency (rate) for a certain congestion duration time (t_x). In other words, the congestion duration frequency calculation unit 83 calculates an occurrence frequency (rate) (Con_x) for each congestion duration time (t_x) (Step S02). The congestion duration time calculation unit 84 calculates a congestion duration time (Ctime) on the basis of the occurrence frequency for each congestion duration time by Expression (1) below (Step S03).

$$Congestion duration time ( Ctime ) = certain congestion duration time ( t\_x ) \times occurrence frequency ( Con\_x ) / \\ occurrence frequency of all congestion duration times \qquad ( 1 )$$

The congestion duration time calculation unit 84 outputs the calculated congestion duration time (Ctime) to the switching determination unit 75a. As described above, the processing of calculating the congestion duration time performed by the future congestion estimation unit 81 illustrated in the flowchart in FIG. 18 ends.

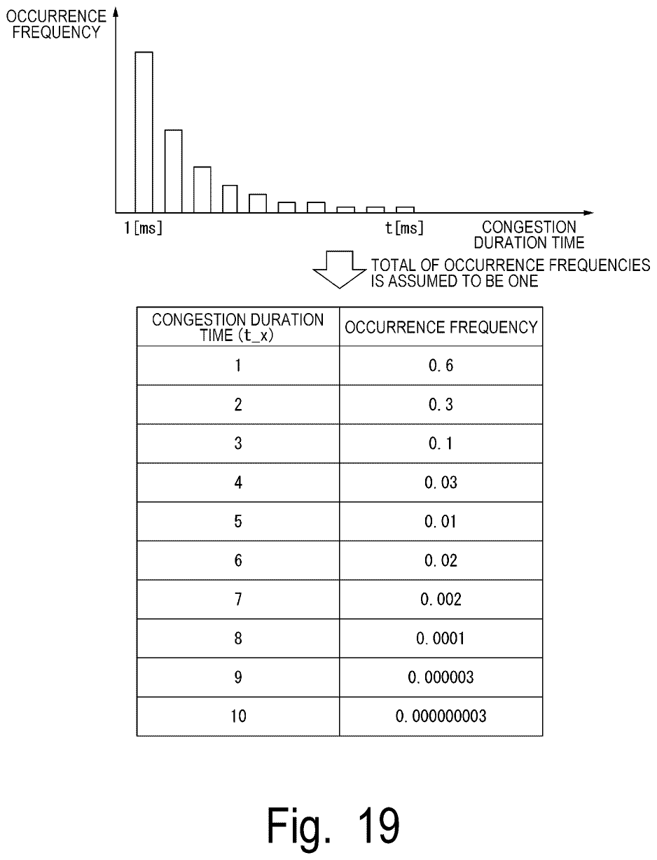

Note that a relationship between a certain congestion duration time (t_X) and an occurrence frequency (rate) is, for example, as represented by the graph or a table illustrated in FIG. 19. FIG. 19 is a diagram for explaining an example of an occurrence frequency (ratio) for each congestion duration time. The upper section of FIG. 19 illustrates an example of the occurrence frequency (rate) for each congestion duration time by a bar graph. In addition, the lower section of FIG. 19 is a table of the occurrence frequency (rate) for each congestion duration time illustrated by the bar graph in the upper section. Here, the total of the occurrence frequencies is defined as one. In other words, the occurrence frequency and the occurrence probability are synonymous here.

Expression (1) above can be represented as Expression (2) below.

$$Congestion duration time in consideration of occurrence frequency = congestion duration time \times \{ occurrence frequency / \\ ( sum of occurrence frequencies from 1 [ ms ] to t [ ms ] ) \} \qquad ( 2 )$$

In other, the congestion duration time in consideration of the occurrence frequency represented by Expression (2) is an expected value of the congestion duration time. On the basis of the above description, if the occurrence frequency (rate) for each congestion duration time is as a numerical value in the table in the lower section of FIG. 19, for example, the congestion duration time is calculated as Expression (3) below.

$$Congestion duration time = 1 \times 0.6 + 2 \times 0.3 + 3 \times 0.1 + … + 9 \times 0.000003 + 10 \times 3. \times {10}^{- 9} \qquad ( 3 )$$

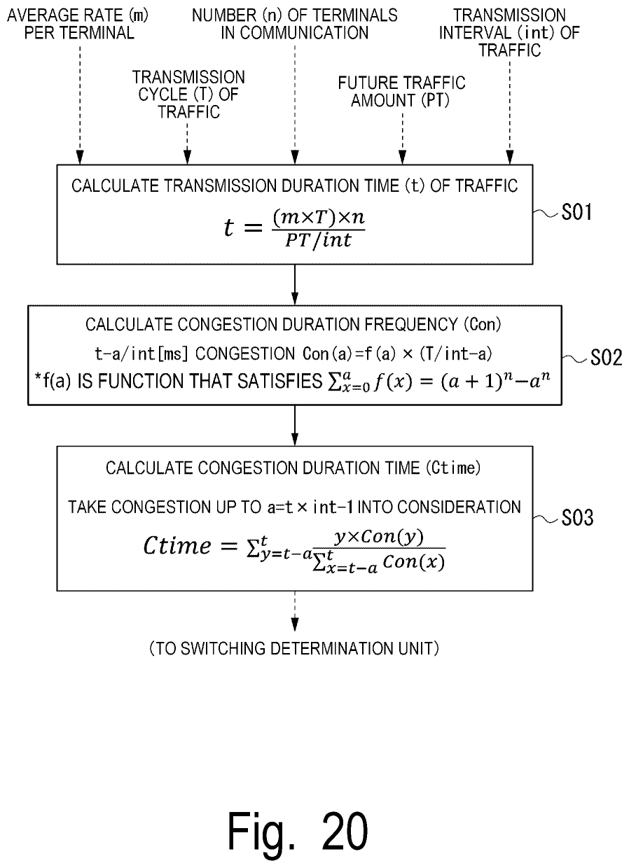

Hereinafter, an example of a more specific calculation method of the processing of calculating the congestion duration time performed by the future congestion estimation unit 81 illustrated in the flowchart of FIG. 18 will be explained. FIG. 20 is a flowchart illustrating a specific example of the processing of calculating the congestion duration time performed by the future congestion estimation unit 81 according to the first embodiment of the present invention. Note that processing in Steps S01 to S03 in the flowchart of FIG. 20 is specific processing of Steps S01 to S03 in the flowchart of FIG. 18, respectively.

The traffic transmission duration time calculation unit 82 calculates a transmission duration time (t) of the traffic on the basis of an average rate (m) per terminal, a transmission cycle (T) of the traffic, the number (n) of terminals in communication, a future traffic amount (PT), and a transmission interval (int) of the traffic (Step S01). The transmission duration time (t) of the traffic is calculated as in Expression (4) below, for example (Step S01).

$$\begin{matrix}[ Math . 1 ] & \\ t = \frac{( m \times T ) \times n}{PT / int} & ( 4 )\end{matrix}$$

The congestion duration frequency calculation unit 83 calculates the occurrence frequency (rate) for each congestion duration time. In a case where transmission start timings of the n terminals overlap, the same traffic occurs during t [ms]. Therefore, the congestion duration frequency which is the congestion occurrence frequency of the congestion duration time of t [ms] is 1ⁿ. In addition, since there are T/int transmission start timings in total, the congestion duration frequency Con(0) of the congestion duration time of t [ms] is as Expression (5) below.

$$Con ( 0 ) = {1}^{n} \times T / int \qquad ( 5 )$$

Here, if a frequency at which the n terminals are in the same traffic for t−a/int [ms] is defined as f(a), a frequency at which the n terminals are in the same traffic for a/int [ms] or more is (a+1)ⁿ. At this time, since the frequency at which the n terminals are in the same traffic during t− (a− 1)/int [ms] is f(a− 1)×2, the frequency at which the n terminals are in the same traffic during t− (a− 2)/int [ms] is f(a− 2)×3, . . . , and congestion occurs during t [ms] is f(0)×(a+1), f(a)=(a+1)ⁿ−f(a)×2−f(a− 1)×3− . . . −f(0)× (a+1). In addition, since there are (T/int− a) transmission start timings in total, the congestion duration frequency Con(a) of the congestion duration time of t− a/int [ms] is as Expression (6) below (Step S02).

$$Con ( a ) = f ( a ) \times ( T / int - a ) \qquad ( 6 )$$

Here, f(a) is a function that satisfies Expression (7) below.

$$\begin{matrix}[ Math . 2 ] & \\ {\sum }_{x = 0}^{a} f ( x ) = {( a + 1 )}^{n} - {a}^{n} & ( 7 )\end{matrix}$$

The congestion duration time calculation unit 84 calculates the congestion duration time on the basis of the occurrence frequency (congestion duration frequency) for each congestion duration time. The congestion duration frequency is a rate of each Con until a time at which traffic becomes identical becomes int [ms]. In the case of the congestion duration time of t [ms], the congestion duration frequency is as Expression (8) below.

$$Con ( t ) / SUM ( Con ( d ) : d = int to t ) \qquad ( 8 )$$

The congestion duration time (Ctime) is calculated by the time when the n terminals become in the same traffic×the frequency in that case. Considering congestion up to a=t×int− 1, Ctime is Expression (9) below.

$$\begin{matrix}[ Math . 3 ] & \\ Ctime = {\sum }_{y = t - a}^{t} \frac{y \times C on ( y )}{{\sum }_{x = t - a}^{t} C o n ( x )} & ( 9 )\end{matrix}$$

The congestion duration time calculation unit 84 outputs the calculated congestion duration time (Ctime) to the switching determination unit 75a. As described above, the processing of calculating the congestion duration time performed by the future congestion estimation unit 81 illustrated in the flowchart in FIG. 20 ends.

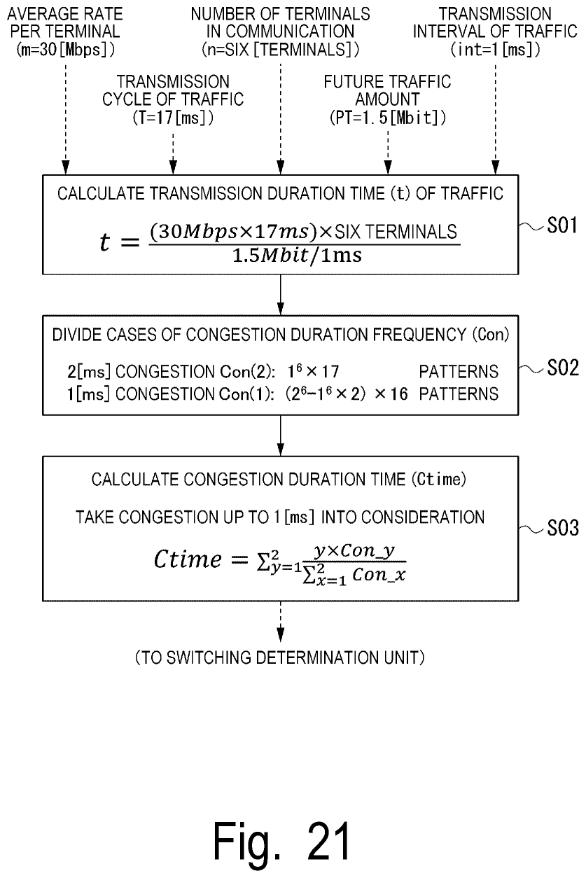

Hereinafter, a numerical value example in which specific numerical values are applied as examples to the specific example of the processing of calculating the congestion duration time performed by the future congestion estimation unit 81 illustrated in the flowchart of FIG. 20 will be described. FIG. 21 is a flowchart illustrating a numerical value example of the processing of calculating the congestion duration time performed by the future congestion estimation unit 81 according to the first embodiment of the present invention. Note that processing in Steps S01 to S03 in the flowchart of FIG. 21 corresponds to application of specific numerical values to the processing in Steps S01 to S03 in the flowchart of FIG. 20, respectively.

In the numerical value example described here, the following communication environment is assumed.
Number n of terminals in communication with DU (number of terminals in communication): 6
Average rate m per terminal: 30 [Mbps]
Traffic transmission cycle T: 17 [ms](60 [fps])
Predicted future traffic amount PT in CU: 1.5 [Mbit]
Traffic transmission interval int: 1 [ms]

Also. the configurations illustrated in FIG. 17 are assumed as a system configuration and each device configuration in the communication system.

The traffic transmission duration time calculation unit 82 calculates the transmission duration time (t) of the traffic on the basis of the average rate (m=30 [Mbps]) per terminal, the transmission cycle (T=17 [ms]) of the traffic, the number (n=6 [terminals]) of terminals in communication, a future traffic amount (PT=1.5 [Mbit]), and a transmission interval (int=1 [ms])) of the traffic. The transmission duration time (t) of the traffic is calculated as Expression (10) below by applying the above numerical value example to Expression (4) described above (Step S01).

$$t = ( 30 [ Mbps ] \times 17 [ ms ] ) \times 6 [ terminals ] / ( 1.5 [ Mbit ] / 1 [ ms ] ) = 2 [ ms ] \qquad ( 10 )$$

Here, the congestion duration time differs depending on the duration time (t=2 [ms]) of the traffic of one terminal and the number (n=6 [terminals]) of terminals in communication. The congestion duration frequency calculation unit 83 calculates the occurrence frequency (rate) for each congestion duration time using divided cases, for example.

In a case where transmission start timings of the six terminals overlap, the terminals are in the same traffic for 2 [ms]. Therefore, the number of cases where congestion in a congestion duration time of 2 [ms] occurs is 1⁶ patterns. In addition, since there are 17 transmission start timings in total, the congestion duration frequency Con(2) in the congestion duration time of 2 [ms] is as Expression (11) below.

$$Con ( 2 ) = {1}^{6} \times 17 = 17 [ patterns ] \qquad ( 11 )$$

Similarly, in a case where the six terminals are in the same traffic for 1 [ms], the number of cases where congestion continues for 1 [ms] or more is 2⁶ patterns. At this time, since 1⁶×2 cases of congestion for 2 [ms] are also included, the number of cases where congestion continues for 1 [ms] is 2⁶−1⁶×2 patterns. In addition, since there are 16 transmission start timings in total, the congestion duration frequency Con(1) in the congestion duration time of 1 [ms] is as Expression (12) below (Step S02).

$$Con ( 1 ) = ( {2}^{6} - {1}^{6} \times 2 ) \times 16 = 992 [ patterns ] \qquad ( 12 )$$

The congestion duration frequency is a rate of each Con until a time at which the terminals become in the same traffic is 1 [ms]. In a case where the transmission cycle of the traffic is 17 [ms], the congestion duration frequency is as Expression (13) below.

$$Con ( t ) / SUM ( Con ( d ) : d = int to t ) \qquad ( 13 )$$

The frequency (probability) of congestion for 2 [ms] is as Expression (14) below.

$$17 / ( 17 + 992 ) = 0.0168 \qquad ( 14 )$$

The frequency (probability) of congestion for 1 [ms] is as Expression (15) below.

$$992 / ( 17 + 992 ) = 0.98324 \qquad ( 15 )$$

The congestion duration time (Ctime) is calculated by the time when the n terminals become in the same traffic×the frequency (probability) in that case. Considering congestion up to a=1 [ms], Ctime is as Expression (16) below (Step S03).

$$Ctime = 2 [ ms ] \times 0.0168 + 1 [ ms ] \times 0.9832 = 1.0168 [ ms ] \qquad ( 16 )$$

The congestion duration time calculation unit 84 outputs the calculated congestion duration time (Ctime) value (1.0168 [ms]) to the switching determination unit 75a. As described above, the processing of calculating the congestion duration time performed by the future congestion estimation unit 81 illustrated in the flowchart in FIG. 21 ends.

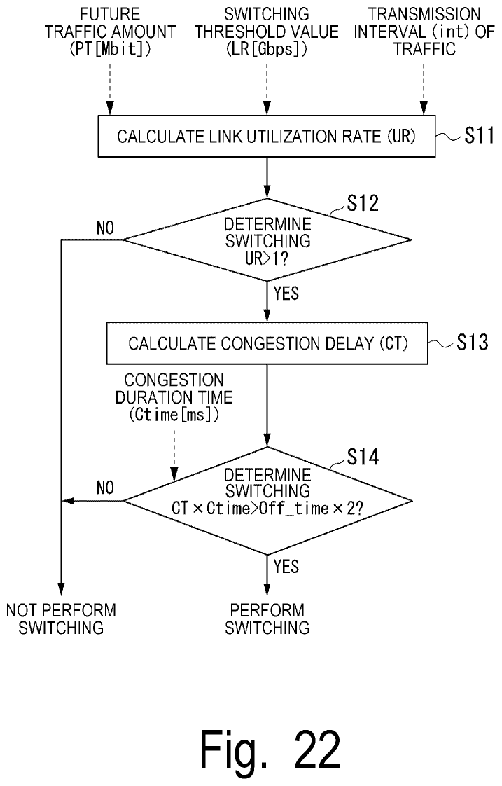

Hereinafter, the processing of determining whether or not to perform the path switching performed by the switching determination unit 75a will be described in more detail. FIG. 22 is a flowchart illustrating a flow of the processing of determining whether or not to perform path switching by the switching determination unit 75a according to the first embodiment of the present invention.

The switching determination unit 76 based on the traffic amount calculates the link utilization rate (UR) on the basis of the future traffic amount (PT), the switching threshold value (LR), and the transmission interval (int) of the traffic (Step S11). The utilization rate (UR) of the link is expressed as Expression (17) below.

$$UR = PT / ( LR \times int ) \qquad ( 17 )$$

The switching determination unit 76 based on the traffic amount determines whether or not congestion will occur on the basis of whether or not UR>1 is established (Step S12). In a case where the switching determination unit 76 based on the traffic amount determines that congestion will not occur (Step S12: No), the path switching is not performed.

In a case where the switching determination unit 76 based on the traffic amount determines that congestion will occur (Step S12: Yes), the switching determination unit 77 based on the congestion duration time calculates the congestion delay (CT) (Step S13). The congestion delay (CT) is expressed as Expression (18) below.

$$CT = ( U R - 1 ) \times int \qquad ( 18 )$$

The switching determination unit 77 based on the congestion duration time determines whether or not a congestion delay (CT×Ctime) value in consideration of several ms ahead is greater than a total value (Off_time×2) of a switch delay and a switch-back delay on the basis of the congestion delay (CT) and the congestion duration time (Ctime) (Step S14).

In a case where the congestion delay time value in consideration of several ms ahead is greater than the total value of the switch delay and the switch-back delay (that is, Expression (19) below is satisfied) (Step S14: Yes), the switching determination unit 77 based on the congestion duration time executes the path switching. Also, in a case where the congestion delay value in consideration of several ms ahead is equal to or less than the total value of the switch delay and the switch-back delay (that is, Expression (19) below is not satisfied) (Step S14: No), the switching determination unit 77 based on the congestion duration time does not execute the path switching.

$$CT \times Ctime > Off\_time \times 2 \qquad ( 19 )$$

As described above, the processing of determining whether or not to perform the path switching performed by the switching determination unit 75a illustrated in the flowchart of FIG. 22 ends.

Note that although the switching determination unit 77 based on the congestion duration time is configured to determine whether or not to perform the path switching on the basis of a product between the congestion delay (CT) at the transmission interval (int) of the traffic and the congestion duration time (Ctime) in the present embodiment, the present invention is not limited thereto. For example, the switching determination unit 77 based on the congestion duration time may be configured to determine whether or not to perform the path switching on the basis of only the value of the congestion duration time (Ctime). In other words, the switching determination unit 77 based on the congestion duration time may determine whether or not to execute the path switching on the basis of whether or not Expression (20) below is satisfied.

$$Ctime > Off\_time \times 2 \qquad ( 20 )$$

Note that although the switching determination unit 77 based on the congestion duration time is configured to determine whether or not to perform the path switching by comparing the value of the product between the congestion delay (CT) and the congestion duration time (Ctime) with the total value of the switch delay and the switch-back delay in the present embodiment, the present invention is not limited thereto. For example, the switching determination unit 77 based on the congestion duration time may determine whether or not to perform the path switching on the basis of whether or not the delay is within a predefined range of allowable delay (hereinafter, also referred to as an “allowable delay”).

As described above, the communication system 1a according to the first embodiment of the present invention predicts the future traffic amount for each link using the prediction information. The communication system 1a calculates the prediction accuracy on the basis of the future traffic amount predicted in the past and the actual traffic amount. The communication system 1a determines, for each upper-order link, the switching threshold value such that the rate to the transmission ability of the link is lower as the prediction accuracy is lower. Also, the communication system 1a calculates the transmission duration time of the traffic per terminal on the basis of the average rate per terminal, the transmission cycle of the traffic, the number of terminals in communication, the future traffic amount, and the transmission interval of the traffic. The communication system 1a calculates an occurrence frequency for each congestion duration time on the basis of the transmission duration time of the traffic, the transmission cycle of the traffic, and the transmission interval of the traffic. The communication system 1a calculates the predicted congestion duration time on the basis of the occurrence frequency for each congestion duration time and the transmission duration time of the traffic. Then, the communication system 1a calculates the utilization rate of the link on the basis of the future traffic amount, the switching threshold value, and the transmission interval of the traffic and determines whether or not congestion will occur on the basis of utilization rate of the link. In a case where it is determined that congestion will occur, the communication system 1a calculates a congestion delay and determines whether or not the congestion delay value in consideration of several ms ahead is greater than the total value of the switching delay (switch delay and the switch-back delay) on the basis of the congestion delay and the congestion duration time. In a case where the congestion delay value is greater than the total value of the switching delay, the communication system 1a determines to execute the path switching.

According to the communication system 1a with such a configuration, the path switching is not performed in a case where the total magnitude of the switching delay is above the magnitude of the congestion delay in a situation in which the switching of the communication paths frequently occurs. In this manner, the communication system 1a according to the first embodiment of the present invention can reduce the communication delay due to congestion in consideration of the communication delay due to switching of the communication paths.

### Second Embodiment

Hereinafter, a communication system 1b according to a second embodiment of the present invention will be described with reference to drawings.

The communication system 1a according to the first embodiment described above is configured such that in the processing of calculating the congestion duration time performed by a future congestion estimation unit 81a, the traffic transmission duration time calculation unit 82 calculates the transmission duration time (t) of the traffic, the congestion duration frequency calculation unit 83 then calculates the occurrence frequency (rate) for each congestion duration time, and the congestion duration time calculation unit 84 calculates the congestion duration time (Ctime) on the basis of the occurrence frequency (congestion duration frequency) for each congestion duration time. However, with such a configuration, it is assumed that a calculation load of the congestion duration time (Ctime) is large and the calculation time becomes long.

On the other hand, in the communication system 1b according to the second embodiment explained below, a traffic transmission duration time calculation unit 82 calculates a transmission duration time (t) of the traffic on the basis of an average rate (m) per terminal, a transmission cycle (T) of a traffic, the number (n) of terminals in communication, a future traffic amount (PT), and a transmission interval (int) of the traffic, and a congestion duration time acquisition unit 84b, which will be described later, then acquires a congestion duration time (Ctime) with reference to congestion duration time information stored in advance without calculation of a congestion duration time (Ctime). The congestion duration time information is data in the form of a table in which the transmission duration time (t) of the traffic, the number (n) of terminals in communication, and the congestion duration time (Ctime) are associated with each other. In this manner, the calculation time of the congestion duration time (Ctime) is reduced.

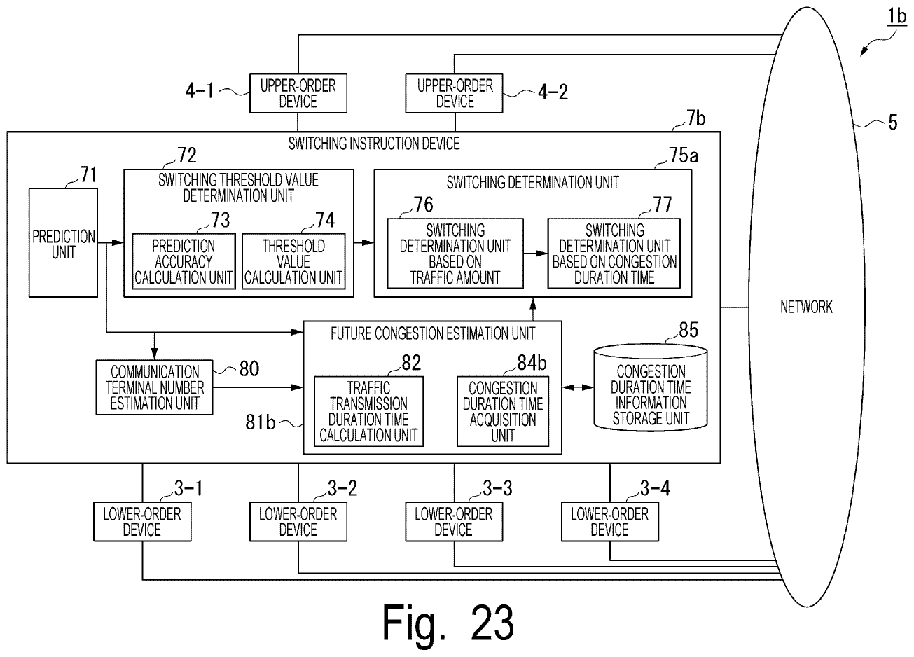

FIG. 23 is a diagram illustrating a configuration of the communication system 1b according to the second embodiment of the present invention. Note that components having functions similar to those of the components of the communication system 1a according to the aforementioned first embodiment will be denoted by the same reference signs out of components included in the communication system 1b and explanation thereof will be omitted.

As illustrated in FIG. 23, the communication system 1b includes a plurality of lower-order devices 3, a plurality of upper-order devices 4, and a switching instruction device 7b. The lower-order devices 3 and the upper-order devices 4 are connected via a network 5. The network 5 is configured to include one or more transfer devices (not illustrated; a device corresponding to a transfer device 15, which is illustrated in FIG. 2 described above). In FIG. 23, four lower-order devices 3 are referred to as lower-order devices 3-1 to 3-4, and two upper-order devices 4 are referred to as upper-order devices 4-1 and 4-2.

As illustrated in FIG. 23, the switching instruction device 7b includes a prediction unit 71, a switching threshold value determination unit 72, a switching determination unit 75a, a communication terminal number estimation unit 80, a future congestion estimation unit 81b, and a congestion duration time information storage unit 85.

The future congestion estimation unit 81b is configured to include a traffic transmission duration time calculation unit 82 and a congestion duration time acquisition unit 84b. The traffic transmission duration time calculation unit 82 calculates the transmission duration time of the traffic per terminal on the basis of the future traffic amount for each link predicted by the prediction unit 71, the average traffic amount, and the number of terminals in communication estimated by the communication terminal number estimation unit 80.

The congestion duration time acquisition unit 84b acquires a traffic transmission duration time calculated by the traffic transmission duration time calculation unit 82 and the number of terminals in communication estimated by the communication terminal number estimation unit 80. The congestion duration time acquisition unit 84b refers to congestion duration time information stored in advance in the congestion duration time information storage unit 85 and acquires future (for example, several ms ahead) congestion duration time corresponding to the acquired traffic transmission duration time and number of terminals in communication. The congestion duration time acquisition unit 84b outputs the acquired future congestion duration time to the switching determination unit 75a.

The congestion duration time information storage unit 85 stores congestion duration time information in advance. As described above, the congestion duration time information is data in the form of a table in which the transmission duration time of the traffic, the number of terminals in communication, and the congestion duration time are associated with each other. The congestion duration time information storage unit 85 is configured of a storage medium such as a random access memory (RAM), a flash memory, an electrically erasable programmable read only memory (EEPROM), a read only memory (ROM), a hard disk drive (HDD), and a solid state drive (SSD), or an arbitrary combination of these storage media, for example.

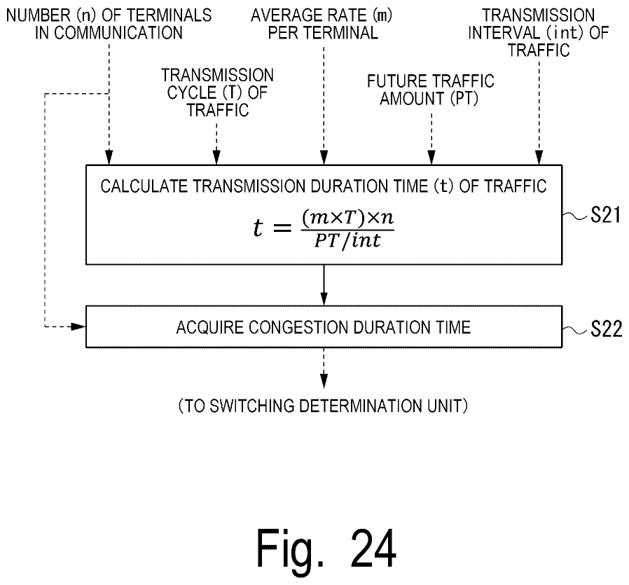

Hereinafter, a specific example of processing of acquiring the congestion duration time performed by the future congestion estimation unit 81b will be described. FIG. 24 is a flowchart illustrating a specific example of the processing of acquiring the congestion duration time performed by the future congestion estimation unit 81b according to the second embodiment of the present invention.

The traffic transmission duration time calculation unit 82 calculates a transmission duration time (t) of the traffic on the basis of an average rate (m) per terminal, a transmission cycle (T) of the traffic, the number (n) of terminals in communication, a future traffic amount (PT), and a transmission interval (int) of the traffic (Step S21). The transmission duration time (t) of the traffic is calculated as in Expression (4) similarly to the aforementioned first embodiment (Step S21).

The congestion duration time acquisition unit 84b acquires information indicating the traffic transmission duration time (t) calculated by the traffic transmission duration time calculation unit 82 and the number (n) of terminals in communication. The congestion duration time acquisition unit 84b refers to the congestion duration time information stored in advance in the congestion duration time information storage unit 85 and acquires the value of the future congestion duration time (Ctime) corresponding to the acquired traffic transmission duration time (t) and the number (n) of terminals in communication (Step S22).

The congestion duration time calculation unit 84 outputs information indicating the acquired congestion duration time (Ctime) to the switching determination unit 75a. As described above, the processing of acquiring congestion duration time performed by the future congestion estimation unit 81b illustrated in the flowchart of FIG. 24 ends.

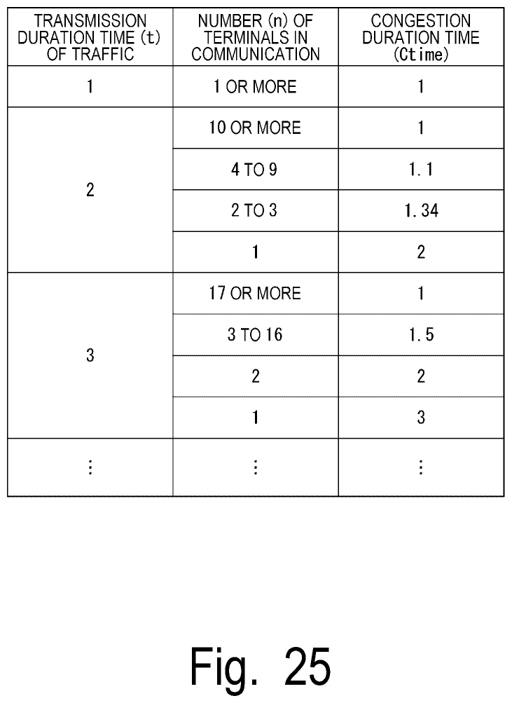

FIG. 25 is a diagram illustrating an example of the congestion duration time information stored in a congestion duration time information storage unit 85 according to the second embodiment of the present invention. As illustrated in FIG. 25, the congestion duration time information is data in the form of a table in which the transmission duration time (t) of the traffic, the number (n) of terminals in communication, and the congestion duration time (Ctime) are associated with each other. The congestion duration time acquisition unit 84b can specify the value of the congestion duration time (Ctime) on the basis of the input values of the transmission duration time (t) of the traffic and the number (n) of terminals in communication by referring to the congestion duration time information.

In a case where the transmission duration time (t) of the traffic is 1 [ms], for example, as illustrated in FIG. 25, the congestion duration time (Ctime) is specified as 1 [ms] regardless of number (n) of terminals in communication. Also, in a case where the transmission duration time (t) of the traffic is 2 [ms], and the number (n) of terminals in communication is two or three, for example, the congestion duration time (Ctime) is specified as 1.34 [ms]. Also, in a case where the transmission duration time (t) of the traffic is 3 [ms], and the number (n) of terminals in communication is within a range of three to sixteen, for example, the congestion duration time (Ctime) is specified as 1.5 [ms].

Note that the congestion duration time information is generated in advance on the basis of, for example, statistical data of congestion duration time in congestion that has occurred in the past and is stored in the congestion duration time information storage unit 85.

As described above, the communication system 1b according to the second embodiment of the present invention stores in advance the congestion duration time information in which the transmission duration time of the traffic, the number of terminals in communication, and the congestion duration time are associated with each other. The communication system 1b calculates the transmission duration time of the traffic per terminal and estimates the number of terminals in communication. The communication system 1b acquires the future (for example, several ms ahead) congestion duration time corresponding to the acquired traffic transmission duration time and the number of terminals in communication with reference to the congestion duration time information. Then, the communication system 1b calculates the utilization rate of the link on the basis of the future traffic amount, a switching threshold value, and the transmission interval of the traffic and determines whether or not congestion will occur on the basis of utilization rate of the link. In a case where it is determined that congestion will occur, the communication system 1b calculates a congestion delay and determines whether or not the congestion delay value in consideration of several ms ahead is greater than the total value of the switching delay (a switch delay and a switch-back delay) on the basis of the congestion delay and the congestion duration time. In a case where the congestion delay value is greater than the total value of the switching delay, the communication system 1b determines to execute path switching.

According to the communication system 1b with such a configuration, the path switching is not performed in a case where the total magnitude of the switching delay is above the magnitude of the congestion delay in a situation in which the switching of the communication paths frequently occurs. In this manner, the communication system 1b according to the second embodiment of the present invention can reduce the communication delay due to congestion in consideration of the communication delay due to switching of the communication paths. In addition, since the communication system 1b includes the configuration to acquire the congestion duration time with reference to the congestion duration time information without calculation of the congestion duration time, the calculation time can be reduced.

### Third Embodiment

Hereinafter, a communication system 1c according to a third embodiment of the present invention will be described with reference to drawings.

The communication system 1a according to the aforementioned first embodiment is configured such that the future congestion estimation unit 81a calculates the congestion duration time (Ctime). On the other hand, in the communication system 1c according to the third embodiment explained below, a future congestion estimation unit 81c, which will be described later, calculates a congestion time in consideration of several ms ahead as well rather than calculating the congestion duration time. Then, a switching determination unit 75c, which will be described later, determines whether or not to perform path switching on the basis of the calculated congestion time in consideration of several ms ahead as well in the communication system 1c.

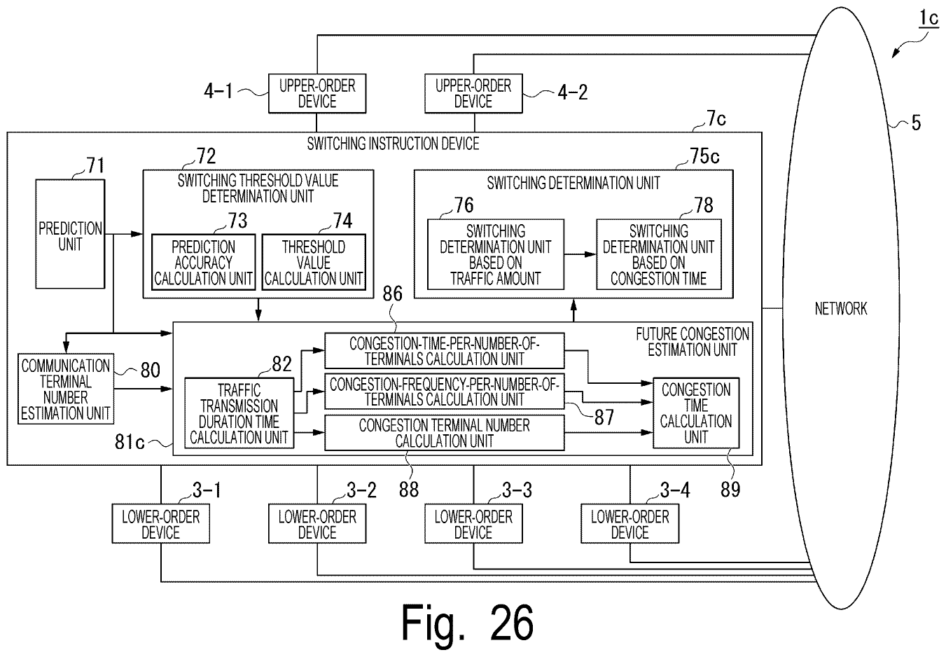

FIG. 26 is a diagram illustrating a configuration of the communication system 1c according to the third embodiment of the present invention. Note that components having functions similar to those of the components of the communication system 1a according to the aforementioned first embodiment will be denoted by the same reference signs out of components included in the communication system 1c and explanation thereof will be omitted.

As illustrated in FIG. 26, the communication system 1c includes a plurality of lower-order devices 3, a plurality of upper-order devices 4, and a switching instruction device 7c. The lower-order devices 3 and the upper-order devices 4 are connected via a network 5. The network 5 is configured to include one or more transfer devices (not illustrated; a device corresponding to a transfer device 15, which is illustrated in FIG. 2 described above). In FIG. 26, four lower-order devices 3 are referred to as lower-order devices 3-1 to 3-4, and two upper-order devices 4 are referred to as upper-order devices 4-1 and 4-2.

As illustrated in FIG. 26, the switching instruction device 7a includes a prediction unit 71, a switching threshold value determination unit 72, a switching determination unit 75c, a communication terminal number estimation unit 80, and a future congestion estimation unit 81c.

The switching determination unit 75c includes a switching determination unit 76 based on the traffic amount and a switching determination unit 78 based on the congestion time. The switching determination unit 76 based on the traffic amount determines, for each link, whether or not congestion will occur in advance using information regarding the predicted future traffic amount value and a switching threshold value of an upper-order link. In a case where occurrence of congestion is predicted, the switching determination unit 76 based on the traffic amount determines to perform path switching for load distribution. Also, in a case where no occurrence of congestion is predicted, the switching determination unit 76 based on the traffic amount determines not to perform the path switching for load distribution.

However, in a case where the switching determination unit 78 based on the congestion time, which will be described later, determines not to perform the path switching even if the switching determination unit 76 based on the traffic amount determines to perform the path switching, the path switching is not performed. The switching determination unit 76 based on the traffic amount outputs information indicating that it is determined that the path switching for load distribution is to be performed to the switching determination unit 78 based on the congestion time.

In a case where the switching determination unit 76 based on the traffic amount determines to perform the path switching, the switching determination unit 78 based on the congestion time determines whether or not to perform the path switching for load distribution in consideration of several ms ahead on the basis of the congestion time calculated by the future congestion estimation unit 81c, which will be described later.

The future congestion estimation unit 81c is configured to include a traffic transmission duration time calculation unit 82, a congestion-time-per-number-of-terminals calculation unit 86, a congestion-frequency-per-number-of-terminals calculation unit 87, a congestion terminal number calculation unit 88, and a congestion time calculation unit 89. The traffic transmission duration time calculation unit 82 calculates a transmission duration time (t) of the traffic per terminal on the basis of a future traffic amount (PT) for each link predicted by the prediction unit 71, an average traffic amount, and the number (n) of terminals in communication estimated by the communication terminal number estimation unit 80.

The congestion-time-per-number-of-terminals calculation unit 86 calculates the congestion time for each number of terminals in communication on the basis of a link rate (LR), the number (n) of terminals in communication, prediction accuracy (A), and a future traffic amount (PT).

The congestion-frequency-per-number-of-terminals calculation unit 87 calculates an occurrence frequency for each number of terminals in communication on the basis of a transmission cycle (T) of the traffic, the number (n) of terminals in communication, a transmission interval (int) of the traffic, and a transmission duration time (t) of the traffic.

The congestion terminal number calculation unit 88 calculates the maximum number of terminals within a range in which congestion will not occur on the basis of the link rate (LR), the number (n) of terminals in communication, the prediction accuracy (A), the future traffic amount (PT), and the transmission interval (int) of the traffic.

The congestion time calculation unit 89 calculates the congestion time on the basis of the congestion time for each number of terminals in communication calculated by the congestion-time-per-number-of-terminals calculation unit 86, the occurrence frequency for each number of terminals in communication calculated by the congestion-frequency-per-number-of-terminals calculation unit 87, and the maximum number of terminals within the range in which congestion will not occur calculated by the congestion terminal number calculation unit 88. The congestion time calculation unit 89 outputs information indicating the calculated congestion time to the switching determination unit 75c.

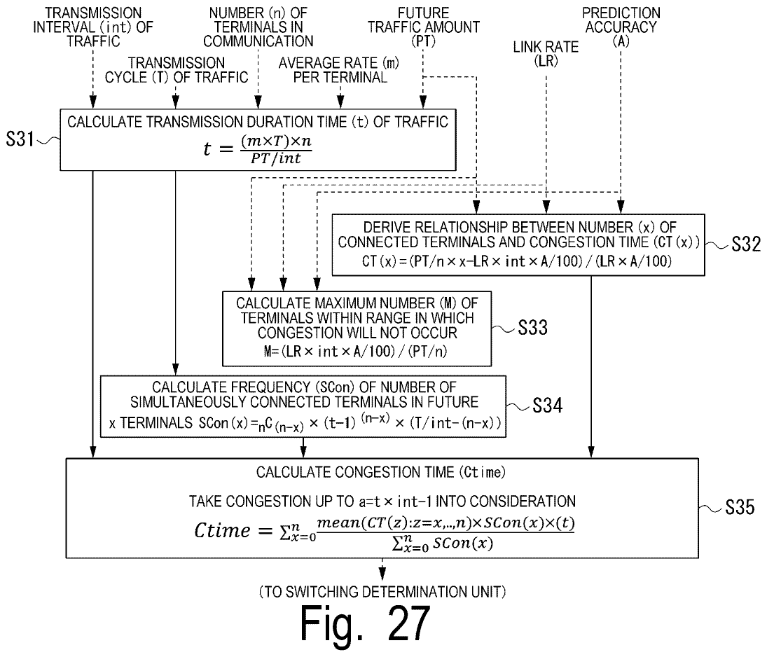

Hereinafter, a specific example of processing of calculating the congestion time performed by the future congestion estimation unit 81c will be explained. FIG. 27 is a flowchart illustrating a specific example of the processing of calculating a congestion time performed by the future congestion estimation unit 81c according to the third embodiment of the present invention.

The traffic transmission duration time calculation unit 82 calculates a transmission duration time (t) of the traffic on the basis of an average rate (m) per terminal, a transmission cycle (T) of the traffic, the number (n) of terminals in communication, a future traffic amount (PT), and a transmission interval (int) of the traffic (Step S31). The transmission duration time (t) of the traffic is calculated as in Expression (4) similarly to the aforementioned first embodiment (Step S31).

The congestion-time-per-number-of-terminals calculation unit 86 derives a relationship between the number (x) of connected terminals and a congestion time (CT(x)) on the basis of the future traffic amount (PT), the prediction accuracy (A), the link rate (LR) acquired from the upper-order devices 4, and the number (x) of connected terminals (Step S32). Assuming that the number of connected terminals is x, the congestion time CT(x) is expressed as Expression (21) below.

$$CT ( x ) = ( PT / n \times x - L R \times int \times A / 100 ) / ( LR \times A / 100 ) \qquad ( 21 )$$

The congestion terminal number calculation unit 88 calculates the maximum number (M) of terminals within a range in which congestion will not occur on the basis of the link rate (LR) acquired from the upper-order devices 4, the number (n) of terminals in communication, the prediction accuracy (A), the future traffic amount (PT), and the transmission interval (int) of the traffic (Step S33). The maximum number M of terminal within the range in which congestion will not occur is expressed as Expression (22) below.

$$M = ( L R \times int \times A / 100 ) / ( PT / n ) \qquad ( 22 )$$

The congestion-frequency-per-number-of-terminals calculation unit 87 calculates a frequency of the number of connected terminals up to the maximum number (M) of terminals within the range in which congestion will not occur (Step S34). When the frequency (hereinafter, referred to as a “frequency of the number of simultaneously connected terminals in the future”) at which x terminals are simultaneously connected after t [ms] is defined as Scon(x), the frequency of the number of simultaneously connected terminals Scon(x) is expressed as Expression (23) below.

$${}_{n} {C}_{( n - x )} \times {( t - 1 )}^{( n - x )} \times ( T / int - ( n - x ) ) \qquad ( 23 )$$

The congestion time calculation unit 89 calculates the congestion time (Ctime) on the basis of the congestion time (CT(x)) for each number of terminals in communication, the occurrence frequency (frequency of the number of simultaneously connected terminals in the future) (Scon(x)) for each number of terminals in communication, and the maximum number (M) of terminals within a range in which congestion will not occur (Step S35). Considering congestion up to a=t×int− 1, Ctime is as in Expression (24) below.

$$\begin{matrix}[ Math . 4 ] & \\ Ctime = {\sum }_{x = 0}^{n} \frac{mean ( CT ( Z ) : z = x , … , n ) \times S c o n ( x ) \times ( t )}{{\sum }_{x = 0}^{n} S C o n ( x )} & ( 24 )\end{matrix}$$

The congestion time calculation unit 89 outputs the calculated congestion time (Ctime) to the switching determination unit 75c. As described above, the processing of calculating the congestion duration time performed by the future congestion estimation unit 81c illustrated in the flowchart in FIG. 27 ends.

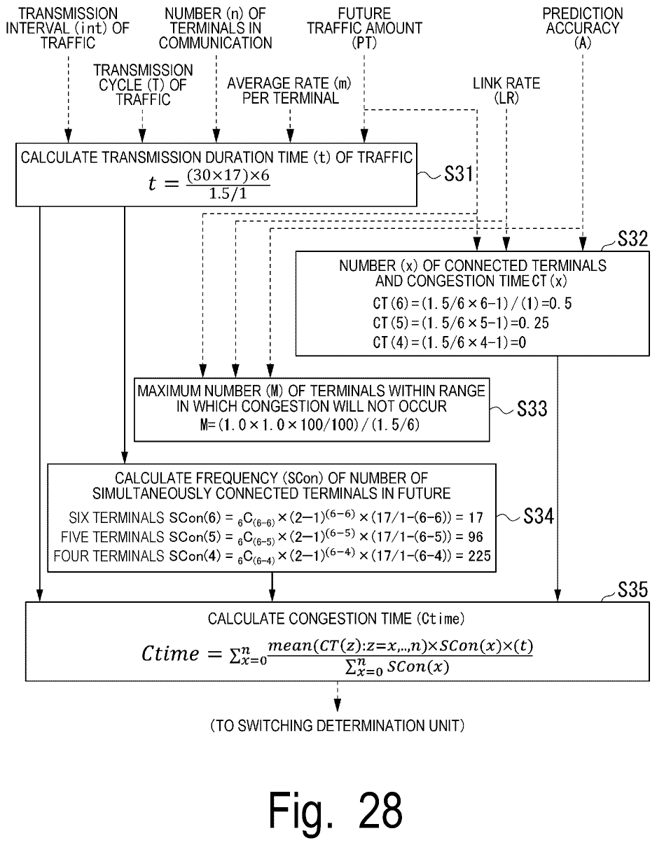

Hereinafter, a numerical value example in which specific numerical values are applied as examples to the specific example of the processing of calculating the congestion duration time performed by the future congestion estimation unit 81c illustrated in the flowchart of FIG. 27 will be described. FIG. 28 is a flowchart illustrating a numerical value example of the processing of calculating the congestion duration time performed by the future congestion estimation unit 81c according to the third embodiment of the present invention. Note that processing in Steps S31 to S35 in the flowchart of FIG. 28 corresponds to application of specific numerical values to the processing in Steps S31 to S35 in the flowchart of FIG. 27, respectively.

The traffic transmission duration time calculation unit 82 calculates the transmission duration time (t) of the traffic on the basis of the average rate (m=30 [Mbps]) per terminal, the transmission cycle (T=17 [ms]) of the traffic, the number (n=6 [terminals]) of terminals in communication, a future traffic amount (PT=1.5 [Mbit]), and a transmission interval (int=1 [ms])) of the traffic (Step S31). If the aforementioned numerical value example is applied to Expression (4) described above, the transmission duration time (t) of the traffic is calculated as in Expression (10) similarly to the aforementioned first embodiment (Step S31).

The congestion-time-per-number-of-terminals calculation unit 86 derives a relationship between the number (x) of connected terminals and a congestion time (CT(x)) on the basis of the future traffic amount (PT=1.5 [Mbit]), the prediction accuracy (A), the link rate (LR) acquired from the upper-order devices 4, and the number (x) of connected terminals (Step S32). Assuming that the number of connected terminals is x, the congestion time CT(x) is expressed as Expressions (25) to (27) below.

$$C T ( 6 ) = ( 1.5 / 6 \times 6 - 1 ) / ( 1 ) = 0.5 \qquad ( 25 )$$

$$CT ( 5 ) = ( 1.5 / 6 \times 5 - 1 ) = 0.25 \qquad ( 26 )$$

$$CT ( 4 ) = ( 1.5 / 6 \times 4 - 1 ) = 0 \qquad ( 27 )$$

The congestion terminal number calculation unit 88 calculates the maximum number (M) of terminals within a range in which congestion will not occur on the basis of the link rate (LR) acquired from the upper-order devices 4, the number (n) of terminals in communication, the prediction accuracy (A), the future traffic amount (PT), and the transmission interval (int) of the traffic (Step S33). The maximum number M of terminal within the range in which congestion will not occur is expressed as Expression (28) below.

$$M = ( 1. \times 1. \times 100 / 100 ) / ( 1.5 / 6 ) = 4 \qquad ( 28 )$$

The congestion-frequency-per-number-of-terminals calculation unit 87 calculates a frequency of the number of connected terminals up to the maximum number (M) of terminals within the range in which congestion will not occur (Step S34). The frequency (the frequency of the number of simultaneously connected terminals in the future) Scon(x) at which x terminals are simultaneously connected t [ms] later is expressed as Expressions (29) to (31) below.

$$\begin{matrix}( Six terminals ) \\ SCon ( 6 ) = {}_{6} {C}_{( 6 - 6 )} \times {( 2 - 1 )}^{( 6 - 6 )} \times ( 17 / 1 - ( 6 - 6 ) ) = 17\end{matrix} \qquad ( 29 )$$

$$\begin{matrix}( Five terminals ) \\ SCon ( 6 ) = {}_{6} {C}_{( 6 - 5 )} \times {( 2 - 1 )}^{( 6 - 5 )} \times ( 17 / 1 - ( 6 - 5 ) ) = 96\end{matrix} \qquad ( 30 )$$

$$\begin{matrix}( Four terminals ) \\ SCon ( 4 ) = {}_{6} {C}_{( 6 - 4 )} \times {( 2 - 1 )}^{( 6 - 4 )} \times ( 17 / 1 - ( 6 - 4 ) ) = 225\end{matrix} \qquad ( 31 )$$

Further calculation results in SCon(3)=280, SCon(2)=195, SCon(1)=72, and SCon(0)=11.

The congestion time calculation unit 89 calculates the congestion time (Ctime) on the basis of the congestion time (CT(x)) for each number of terminals in communication, the occurrence frequency (frequency of the number of simultaneously connected terminals in the future) (Scon(x)) for each number of terminals in communication, and the maximum number (M) of terminals within a range in which congestion will not occur (Step S35). Considering congestion up to a=t×int− 1, Ctime is as in Expression (24) above. If each of the above values is applied to Expression (24), Ctime=0.71 [ms].

The congestion time calculation unit 89 outputs the calculated congestion time (Ctime) to the switching determination unit 75c. As described above, the processing of calculating the congestion duration time performed by the future congestion estimation unit 81c illustrated in the flowchart in FIG. 28 ends.

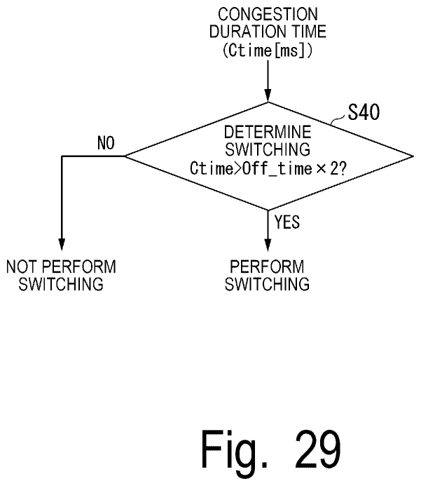

Hereinafter, the processing of determining whether or not to perform the path switching performed by the switching determination unit 75c will be described in more detail. FIG. 29 is a flowchart illustrating a flow of the processing of determining whether or not to perform the path switching by the switching determination unit 75c according to the third embodiment of the present invention.

The switching determination unit 78 based on the congestion time determines whether or not the value of the congestion time (Ctime) acquired from the future congestion estimation unit 81c is greater than the total value (Off_time×2) of the switch delay and the switch-back delay (Step S40).

In a case where the value (congestion delay) of the congestion time (Ctime) is greater than the total value (switching delay) of the switch delay and the switch-back delay (that is, a case where Expression (32) below is satisfied) (Step S40: Yes), the switching determination unit 78 based on the congestion time executes the path switching. Also, in a case where the value (congestion delay) of the congestion time (Ctime) is equal to or less than the total value (switching delay) of the switch delay and the switch-back delay (that is, a case where Expression (32) below is not satisfied) (Step S14: No), the switching determination unit 78 based on the congestion time does not execute the path switching.

$$Ctime > Off\_time \times 2 \qquad ( 32 )$$

As described above, the processing of determining whether or not to perform the path switching performed by the switching determination unit 75c illustrated in the flowchart of FIG. 29 ends.

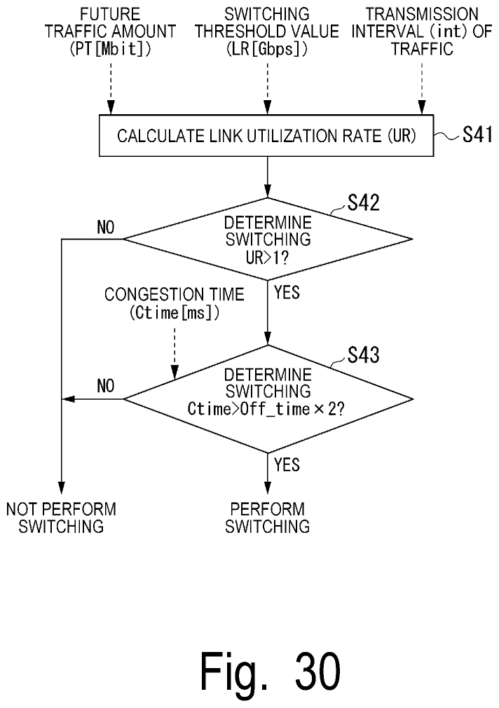

In addition, in order to more quickly perform the processing of determining whether or not to perform the path switching, the switching determination unit 76 based on the traffic amount may determine whether or not to perform the path switching on the basis of the utilization rate of the link calculated from the switching threshold value and the future traffic amount before the switching determination unit 78 based on the congestion time determines whether or not to perform the path switching on the basis of the congestion time (Ctime) (the determination of whether or not to perform the path switching through the processing illustrated in FIG. 29). In this case, processing of determining whether or not to perform the path switching as in FIG. 30, for example, is performed.

FIG. 30 is a flowchart illustrating a flow of the processing of determining whether or not to perform the path switching by the switching determination unit 75c according to the third embodiment of the present invention. The switching determination unit 76 based on the traffic amount calculates the utilization rate (UR) of the link on the basis of the future traffic amount (PT), the switching threshold value (LR), and the transmission interval (int) of the traffic (Step S41). The utilization rate (UR) of the link is expressed as Expression (17) described above.

The switching determination unit 76 based on the traffic amount determines whether or not congestion will occur on the basis of whether or not UR>1 is established (Step S42). In a case where the switching determination unit 76 based on the traffic amount determines that congestion will not occur (Step S42: No), the path switching is not performed.

In a case where the switching determination unit 76 based on the traffic amount determines that congestion will occur (Step S42: Yes), the switching determination unit 78 based on the congestion time determines whether or not the congestion time (Ctime) value acquired from the future congestion estimation unit 81c is greater than the total value (Off_time×2) of the switch delay and the switch-back delay (Step S43).

In a case where the value (congestion delay) of the congestion time (Ctime) is greater than the total value (switching delay) of the switch delay and the switch-back delay (that is, a case where Expression (32) below is satisfied) (Step S43: Yes), the switching determination unit 78 based on the congestion time determines to execute the path switching. Also, in a case where the value (congestion delay) of the congestion time (Ctime) is equal to or less than the total value (switching delay) of the switch delay and the switch-back delay (that is, a case where Expression (32) described above is not satisfied) (Step S43: No), the switching determination unit 78 based on the congestion time determines not to execute the path switching.

As described above, the processing of determining whether or not to perform the path switching performed by the switching determination unit 75c illustrated in the flowchart of FIG. 30 ends.

Note that although the switching determination unit 78 based on the congestion time is configured to determine whether or not to perform the path switching by comparing the value of the congestion time (congestion delay) (CT) with the total value (the total of the switching delays) of the switch delay and the switch-back delay in the present embodiment, the present invention is not limited thereto. For example, the switching determination unit 78 based on the congestion time may determine whether or not to perform the path switching on the basis of whether or not the delay is within a range of a predefined allowable delay.

As described above, the communication system 1c according to the third embodiment calculates the congestion time for each number of terminals in communication on the basis of the link rate, the number of terminals in communication, the prediction accuracy, and the future traffic amount. The communication system 1c calculates the occurrence frequency for each number of terminals in communication on the basis of the transmission cycle of the traffic, the number of terminals in communication, the transmission interval of the traffic, and the transmission duration time of the traffic. The communication system 1c calculates the maximum number of terminals within the range in which congestion will not occur on the basis of the link rate, the number of terminals in communication, the prediction accuracy, the future traffic amount, and the transmission interval of the traffic. The communication system 1c calculates the congestion time on the basis of the congestion time for each number of terminals in communication, the occurrence frequency for each number of terminals in communication, and the maximum number of terminals within the range in which congestion will not occur. Then, the communication system 1c determines whether or not the value of the congestion time (congestion delay) is greater than the total value of the switch delay and the switch-back delay (switching delay). In a case where the value of the congestion delay is greater than the total value of the switching delay, the communication system 1c determines to execute the path switching.

According to the communication system 1c with such a configuration, the path switching is not performed in a case where the total magnitude of the switching delay is above the magnitude of the congestion delay in a situation in which the switching of the communication paths frequently occurs. In this manner, the communication system 1c according to the third embodiment of the present invention can reduce the communication delay due to congestion in consideration of the communication delay due to switching of the communication paths.

### Fourth Embodiment

Hereinafter, a communication system 1d according to a fourth embodiment of the present invention will be explained with reference to drawings.

The communication system 1c according to the aforementioned third embodiment is configured such that the congestion-time-per-number-of-terminals calculation unit 86 calculates the congestion time for each number of terminals in communication, the congestion-frequency-per-number-of-terminals calculation unit 87 calculates the occurrence frequency of congestion for each number of terminals in communication, the congestion terminal number calculation unit 88 calculates the maximum number of terminals within the range in which congestion will not occur, and the congestion time calculation unit 89 calculates the congestion time on the basis of these calculated values. However, a high calculation load for the congestion time and a long calculation time are assumed in such a configuration.

On the other hand, in the communication system 1d according to the fourth embodiment explained below, a traffic transmission duration time calculation unit 82 calculates a transmission duration time (t) of a traffic on the basis of an average rate (m) per terminal, a transmission cycle (T) of the traffic, the number (n) of terminals in communication, a future traffic amount (PT), and a transmission interval (int) of the traffic, a maximum congestion time calculation unit 91, which will be described later, calculates a maximum congestion time (CT_max) without calculation of the occurrence frequency of congestion, and a congestion time acquisition unit 89d, which will be described later, acquires a congestion time (Ctime) with reference to congestion time information stored in advance on the basis of the traffic transmission duration time (t) and the number (n) of the terminals in communication. The congestion duration time information is data in the form of a table in which the transmission duration time (t) of the traffic, the number (n) of terminals in communication, the maximum congestion time (CT_max), and the congestion duration time (Ctime) are associated with each other. In this manner, the calculation time of the congestion time is reduced.

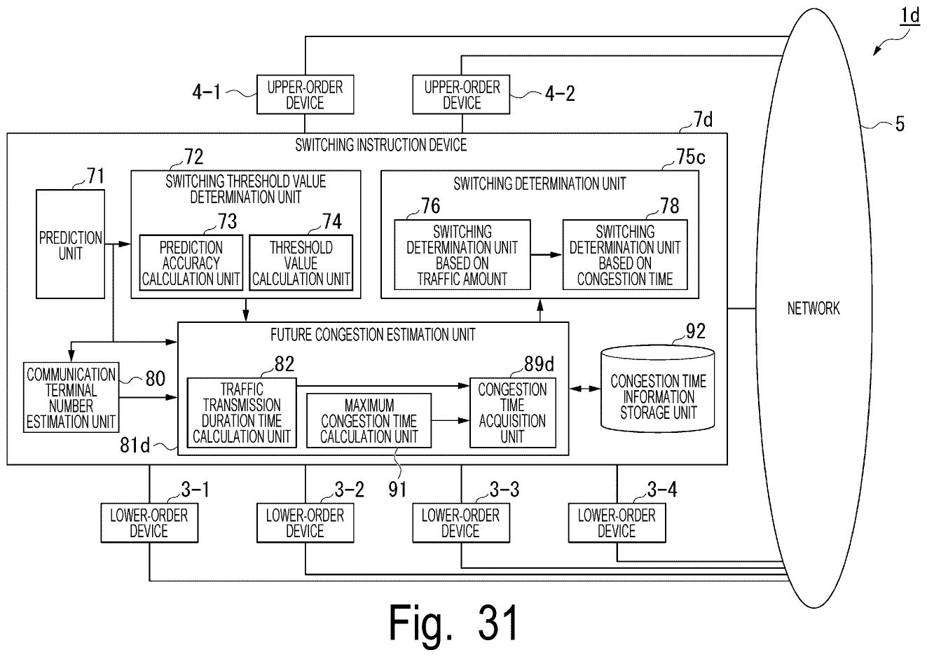

FIG. 31 is a diagram illustrating a configuration of the communication system 1d according to the fourth embodiment of the present invention. Note that components having functions similar to those of the components of the communication system 1c according to the aforementioned third embodiment will be denoted by the same reference signs out of components included in the communication system 1d and explanation thereof will be omitted.

As illustrated in FIG. 31, the communication system 1d includes a plurality of lower-order devices 3, a plurality of upper-order devices 4, and a switching instruction device 7d. The lower-order devices 3 and the upper-order devices 4 are connected via a network 5. The network 5 is configured to include one or more transfer devices (not illustrated; a device corresponding to a transfer device 15, which is illustrated in FIG. 2 described above). In FIG. 31, four lower-order devices 3 are referred to as lower-order devices 3-1 to 3-4, and two upper-order devices 4 are referred to as upper-order devices 4-1 and 4-2.

As illustrated in FIG. 31, the switching instruction device 7d includes a prediction unit 71, a switching threshold value determination unit 72, a switching determination unit 75c, a communication terminal number estimation unit 80, a future congestion estimation unit 81d, and a congestion time information storage unit 92.

The future congestion estimation unit 81d is configured to include a traffic transmission duration time calculation unit 82, a maximum congestion time calculation unit 91, and a congestion time acquisition unit 89d. The traffic transmission duration time calculation unit 82 calculates the transmission duration time (t) of the traffic per terminal on the basis of the future traffic amount for each link predicted by the prediction unit 71, the average traffic amount, and the number of terminals in communication estimated by the communication terminal number estimation unit 80. The traffic transmission duration time calculation unit 82 outputs the calculated value of the transmission duration time (t) of the traffic per terminal to the congestion time acquisition unit 89d.

The maximum congestion time calculation unit 91 calculates the maximum congestion time (CT_max) on the basis of a future traffic amount (PT), a link rate (LR) acquired from the upper-order devices 4, and prediction accuracy (A). The maximum congestion time calculation unit 91 outputs the calculated value of the maximum congestion time (CT_max) to the congestion time acquisition unit 89d.

The congestion time acquisition unit 89d acquires information indicating the traffic transmission duration time (t) calculated by the traffic transmission duration time calculation unit 82, the maximum congestion time (CT_max) calculated by the maximum congestion time calculation unit 91, and the number (n) of terminals in communication estimated by the communication terminal number estimation unit 80. The congestion time acquisition unit 89d acquires the congestion time (Ctime) corresponding to the acquired traffic transmission duration time (t), maximum congestion time (CT_max), and number (n) of terminals in communication with reference to the congestion time information stored in advance in the congestion time information storage unit 92. The congestion time acquisition unit 89d outputs the acquired value of congestion time (Ctime) to the switching determination unit 75c.

The congestion time information storage unit 92 stores congestion time information in advance. As described above, the congestion time information is data in the form of a table in which the transmission duration time (t) of the traffic, the number (n) of terminals in communication, the maximum congestion time (CT_max), and the congestion time (Ctime) are associated with each other. The congestion time information storage unit 92 is configured of a storage medium such as a RAM, a flash memory, an EEPROM, a ROM, an HDD, or an SSD or an arbitrary combination of these storage media, for example.

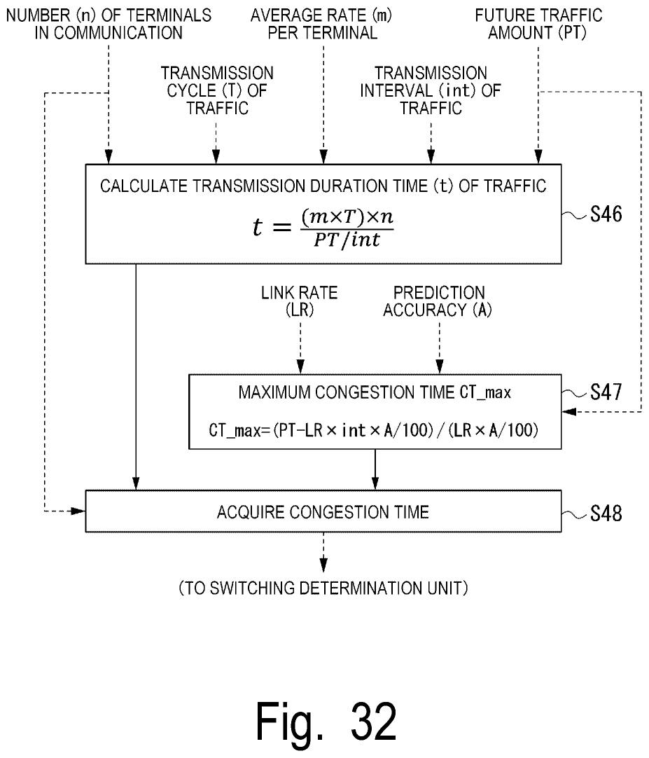

Hereinafter, a specific example of processing of acquiring the congestion time performed by the future congestion estimation unit 81d will be described. FIG. 32 is a flowchart illustrating a specific example of the processing of acquiring the congestion time performed by the future congestion estimation unit 81d according to the fourth embodiment of the present invention.

The traffic transmission duration time calculation unit 82 calculates a transmission duration time (t) of the traffic on the basis of an average rate (m) per terminal, a transmission cycle (T) of the traffic, the number (n) of terminals in communication, a future traffic amount (PT), and a transmission interval (int) of the traffic (Step S46). The transmission duration time (t) of the traffic is calculated as in Expression (4) similarly to the aforementioned first embodiment (Step S46).

The maximum congestion time calculation unit 91 calculates the maximum congestion time (CT_max) on the basis of the future traffic amount (PT), the link rate (LR) acquired from the upper-order devices 4, and the prediction accuracy (A) (Step S47). The maximum congestion time (CT_max) is calculated by Expression (33) below, for example.

$$CT\_max = ( P T - LR \times int \times A / 100 ) / ( LR \times A / 100 ) \qquad ( 33 )$$

The congestion time acquisition unit 89d acquires information indicating the traffic transmission duration time (t) calculated by the traffic transmission duration time calculation unit 82, the maximum congestion time (CT_max) calculated by the maximum congestion time calculation unit 91, and the number (n) of terminals in communication estimated by the communication terminal number estimation unit 80. The congestion time acquisition unit 89d acquires the congestion time (Ctime) corresponding to the acquired traffic transmission duration time (t), maximum congestion time (CT_max), and number (n) of terminals in communication with reference to the congestion time information stored in advance in the congestion time information storage unit 92 (Step S48).

The congestion time acquisition unit 89d outputs the acquired value of congestion time (Ctime) to the switching determination unit 75c. As described above, the processing of acquiring the congestion time performed by the future congestion estimation unit 81d illustrated in the flowchart of FIG. 32 ends.

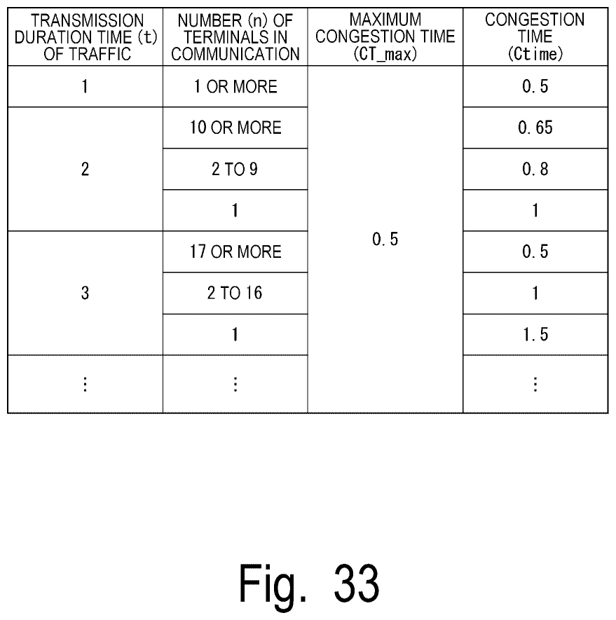

FIG. 33 is a diagram illustrating an example of the congestion time information stored in a congestion time information storage unit 92 according to the fourth embodiment of the present invention. As illustrated in FIG. 33, the congestion time information is data in the form of a table in which the transmission duration time (t) of the traffic, the number (n) of terminals in communication, the maximum congestion time (CT_max), and the congestion time (Ctime) are associated with each other. The congestion time acquisition unit 89d can specify the value of the congestion time (Ctime) on the basis of the input values of the transmission duration time (t) of the traffic, the number (n) of terminals in communication, and the maximum congestion time (CT_max) with reference to the congestion time information.

In a case where the transmission duration time (t) of the traffic is 1 [ms], for example, as illustrated in FIG. 33, the congestion time (Ctime) is specified as 0.5 [ms] regardless of number (n) of terminals in communication. Also, in a case where the transmission duration time (t) of the traffic is 2 [ms], and the number (n) of terminals in communication is within a range of two to nine, for example, the congestion duration time (Ctime) is specified as 0.8 [ms]. Also, in a case where the transmission duration time (t) of the traffic is 3 [ms], and the number (n) of terminals in communication is equal to or greater than seventeen, for example, the congestion duration time (Ctime) is specified as 0.5 [ms].

Note that the congestion time information is generated in advance on the basis of, for example, statistical data of congestion time in congestion that has occurred in the past and is stored in the congestion time information storage unit 92.

As described above, the communication system 1d according to the fourth embodiment of the present invention stores in advance the congestion time information in which the transmission duration time of the traffic, the number of terminals in communication, the maximum congestion time, and the congestion duration time are associated with each other. The communication system 1d calculates the traffic transmission duration time, calculates the maximum congestion time, and estimates the number of terminals in communication. The communication system 1d acquires the congestion time corresponding to the traffic transmission duration time, the maximum congestion time, and the number of terminals in communication with reference to the congestion time information. Then, the communication system 1d determines whether or not the value of the congestion time (congestion delay) is greater than the total value of the switch delay and the switch-back delay (switching delay). In a case where the value of the congestion delay is greater than the total value of the switching delay, the communication system 1d determines to execute the path switching.

According to the communication system 1d with such a configuration, the path switching is not performed in a case where the total magnitude of the switching delay is above the magnitude of the congestion delay in a situation in which the switching of the communication paths frequently occurs. In this manner, the communication system 1d according to the fourth embodiment of the present invention can reduce the communication delay due to congestion in consideration of the communication delay due to switching of the communication paths. In addition, since the communication system 1d has the configuration to acquire the congestion time with reference to the congestion time information without calculation of the congestion time, the calculation time can be reduced.

### Fifth Embodiment

Hereinafter, a communication system 1e according to a fifth embodiment of the present invention will be described with reference to drawings.

The communication system 1a according to the aforementioned first embodiment is configured such that the future congestion estimation unit 81a calculates the congestion duration time (Ctime). Then, the communication system 1a is configured such that the switching determination unit 75a determines whether or not to perform the path switching on the basis of the calculated congestion duration rate. On the other hand, in the communication system 1e according to the fifth embodiment described below, a future congestion estimation unit 81e, which will be described later, calculates a congestion duration rate which is a probability at which congestion will also continue in the next period, rather than calculating the congestion duration time. Then, a switching determination unit 75e, which will be described later, determines whether or not to perform path switching on the basis of the calculated congestion duration rate in the communication system 1e.

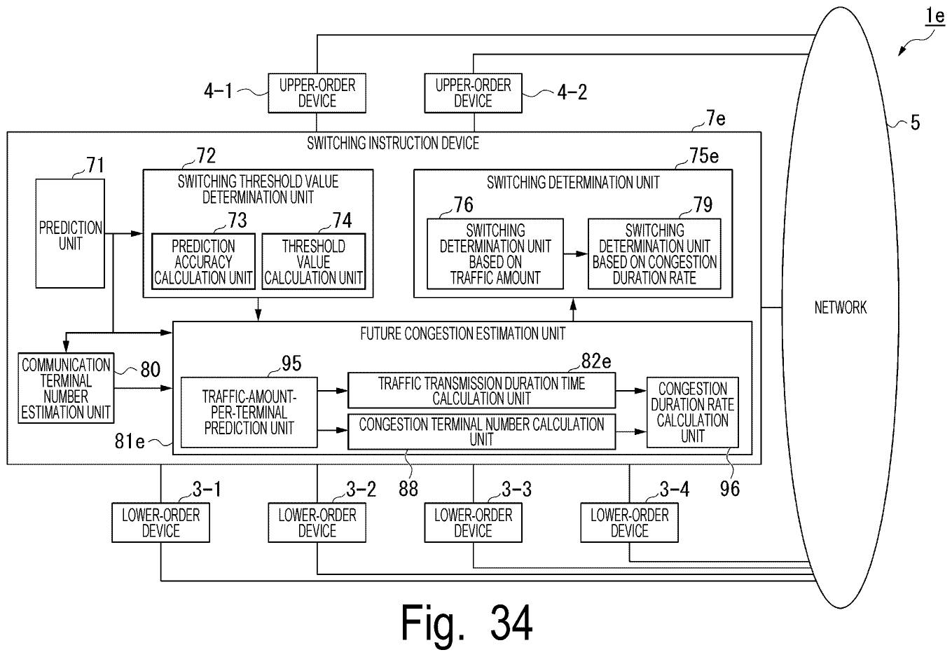

FIG. 34 is a diagram illustrating a configuration of the communication system 1e according to the fifth embodiment of the present invention. Note that components having functions similar to those of the components of the communication system 1a according to the aforementioned first embodiment will be denoted by the same reference signs out of components included in the communication system 1e and explanation thereof will be omitted.

As illustrated in FIG. 34, the communication system 1e includes a plurality of lower-order devices 3, a plurality of upper-order devices 4, and a switching instruction device 7e. The lower-order devices 3 and the upper-order devices 4 are connected via a network 5. The network 5 is configured to include one or more transfer devices (not illustrated; a device corresponding to a transfer device 15, which is illustrated in FIG. 2 described above). In FIG. 34, four lower-order devices 3 are referred to as lower-order devices 3-1 to 3-4, and two upper-order devices 4 are referred to as upper-order devices 4-1 and 4-2.

As illustrated in FIG. 34, the switching instruction device 7e includes a prediction unit 71, a switching threshold value determination unit 72, a switching determination unit 75e, a communication terminal number estimation unit 80, and a future congestion estimation unit 81e.

The switching determination unit 75e includes a switching determination unit 76 based on the traffic amount and a switching determination unit 79 based on the congestion duration rate. The switching determination unit 76 based on the traffic amount determines, for each link, whether or not congestion will occur in advance using information regarding the predicted future traffic amount value and the switching threshold value of the upper-order link. In a case where occurrence of congestion is predicted, the switching determination unit 76 based on the traffic amount determines to perform path switching for load distribution. Also, in a case where no occurrence of congestion is predicted, the switching determination unit 76 based on the traffic amount determines not to perform the path switching for load distribution.

However, in a case where the switching determination unit 79 based on the congestion duration rate, which will be described later, determines not to perform the path switching even if the switching determination unit 76 based on the traffic amount determines to perform the path switching, the path switching is not performed. The switching determination unit 76 based on the traffic amount outputs information indicating that it is determined that the path switching for load distribution is to be performed to the switching determination unit 79 based on the congestion duration rate.

In a case where the switching determination unit 76 based on the traffic amount determines to perform the path switching, the switching determination unit 79 based on the congestion duration rate determines whether or not to perform the path switching for load distribution on the basis of a congestion duration rate calculated by a future congestion estimation unit 81e, which will be described later. The switching determination unit 79 based on the congestion duration rate determines to perform the path switching on the basis of the congestion duration rate and a rate between a switching time (or an allowable delay) and the congestion time. For example, the switching determination unit 79 based on the congestion duration rate determines to perform the path switching on the basis of the congestion duration rate and a value calculated from a ratio of the switching time (or the allowable delay) with respect to the congestion time.

The future congestion estimation unit 81e is configured to include a traffic-amount-per-terminal prediction unit 95, a traffic transmission duration time calculation unit 82e, a congestion terminal number calculation unit 88, and a congestion duration rate calculation unit 96.

The traffic-amount-per-terminal prediction unit 95 predicts the future traffic amount (PT_1) per terminal on the basis of the future traffic amount (PT) for each link predicted by the prediction unit 71 and the number (n) of terminals in communication estimated by the communication terminal number estimation unit 80. The traffic-amount-per-terminal prediction unit 95 outputs information indicating the predicted future traffic amount (PT_1) per terminal to the traffic transmission duration time calculation unit 82e and the congestion terminal number calculation unit 88.

The traffic transmission duration time calculation unit 82e calculates the transmission duration time (t) of the traffic per terminal on the basis of the future traffic amount (PT_1) per terminal predicted by the traffic-amount-per-terminal prediction unit 95, an average rate (m) per terminal acquired from the lower-order devices 3, and a transmission cycle (T) of the traffic per terminal acquired from the lower-order devices 3. Note that a configuration may also be employed in which the average rate (m) per terminal and the transmission cycle (T) of traffic per terminal are acquired in advance. The traffic transmission duration time calculation unit 82e outputs the calculated value of the transmission duration time (t) of the traffic per terminal to the congestion duration rate calculation unit 96.

The congestion terminal number calculation unit 88 calculates the maximum number (M) of terminals within a range in which congestion will not occur on the basis of the future traffic amount (PT_1) per terminal predicted by the traffic-amount-per-terminal prediction unit 95, the link rate (LR) acquired from the upper-order devices 4, and the prediction accuracy (A). Note that a configuration may also be employed in which the link rate (LR) is acquired in advance. The congestion terminal number calculation unit 88 outputs the calculated value of the maximum number (M) of connected terminals within the range in which congestion will not occur to the congestion duration rate calculation unit 96.

The congestion duration rate calculation unit 96 calculates a congestion duration rate (Rcon) on the basis of the transmission duration time (t) of the traffic per terminal calculated by the traffic transmission duration time calculation unit 82e, the maximum number (M) of connected terminals within the range in which congestion will not occur calculated by the congestion terminal number calculation unit 88, and the number (n) of terminals in communication estimated by the communication terminal number estimation unit 80. The congestion duration rate calculation unit 96 outputs the calculated value of the congestion duration rate (Rcon) to the switching determination unit 75e.

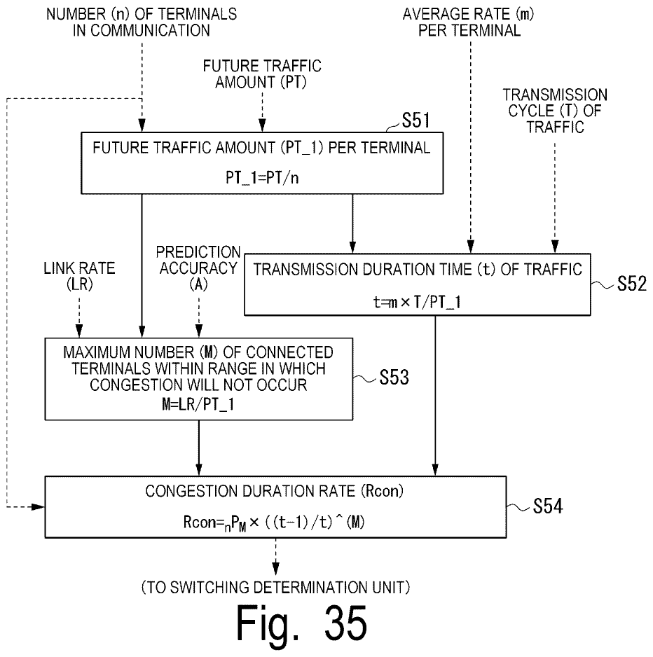

Hereinafter, a specific example of processing of calculating the congestion duration rate performed by the future congestion estimation unit 81e will be explained. FIG. 35 is a flowchart illustrating a specific example of the processing of calculating the congestion duration rate performed by a future congestion estimation unit 81e according to the fifth embodiment of the present invention.

The traffic-amount-per-terminal prediction unit 95 predicts the future traffic amount (PT_1) per terminal on the basis of the future traffic amount (PT) for each link predicted by the prediction unit 71 and the number (n) of terminals in communication estimated by the communication terminal number estimation unit 80 (Step S51). The future traffic amount (PT_1) is calculated by Expression (34) below, for example.

$$PT\_ 1 = PT / n \qquad ( 34 )$$

The traffic transmission duration time calculation unit 82e calculates the transmission duration time (t) of the traffic per terminal on the basis of the future traffic amount (PT_1) per terminal predicted by the traffic-amount-per-terminal prediction unit 95, an average rate (m) per terminal, and a transmission cycle (T) of the traffic per terminal (Step S52). The transmission duration time (t) of the traffic is calculated by Expression (35) below, for example.

$$t = m \times T / PT\_ 1 \qquad ( 35 )$$

The congestion terminal number calculation unit 88 calculates the maximum number (M) of connected terminals within a range in which congestion will not occur on the basis of the future traffic amount (PT_1) per terminal predicted by the traffic-amount-per-terminal prediction unit 95, the link rate (LR) acquired from the upper-order devices 4, and the prediction accuracy (A) (Step S53). The maximum number (M) of the connected terminals within the range in which congestion will not occur is calculated by Expression (36) below, for example.

$$M = LR / PT\_ 1 \qquad ( 36 )$$

The congestion duration rate calculation unit 96 calculates the congestion duration rate (Rcon) on the basis of the transmission duration time (t) of the traffic per terminal calculated by the traffic transmission duration time calculation unit 82e, the maximum number (M) of connected terminals within the range in which congestion will not occur calculated by the congestion terminal number calculation unit 88, and the number (n) of terminals in communication estimated by the communication terminal number estimation unit 80 (Step S54). The congestion duration rate (Rcon) is calculated by Expression (37) below, for example.

$$Rcon = {}_{n} {P}_{M} \times {( ( t - 1 ) / t )}^{M} \qquad ( 37 )$$

The congestion duration rate calculation unit 96 outputs the calculated value of the congestion duration rate (Rcon) to the switching determination unit 75e. As described above, the processing of acquiring the congestion time performed by the future congestion estimation unit 81e illustrated in the flowchart of FIG. 35 ends.

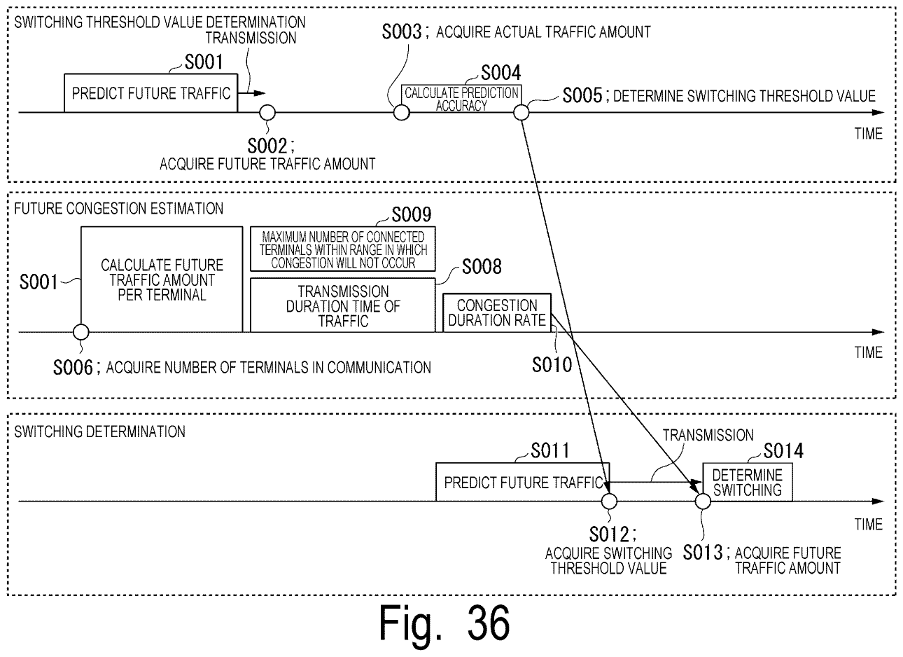

FIG. 36 is a diagram illustrating a flow of processing performed by the switching instruction device 7e according to the fifth embodiment of the present invention. The prediction unit 71 predicts the future traffic amount of the upper-order link in a period D(a), for example (Step S001). The prediction accuracy calculation unit 73 acquires the future traffic amount predicted in Step S001 from the prediction unit 71 and stores the information until the actual traffic amount in the period D(a) is acquired (Step S002). The prediction accuracy calculation unit 73 receives the actual traffic amount in the period D(a) of the upper-order link (Step S003). The prediction accuracy calculation unit 73 calculates prediction accuracy on the basis of the stored future traffic amount in the period D(a) and the received actual traffic amount in the period D(a) (Step S004). The threshold value calculation unit 74 determines the switching threshold value on the basis of the link rate of the upper-order link and the prediction accuracy (Step S005). The threshold value calculation unit 74 outputs the determined switching threshold value to the switching determination unit 175.

The traffic-amount-per-terminal prediction unit 95 acquires the future traffic amount for each link predicted by the prediction unit 71 and the number of terminals in communication estimated by the communication terminal number estimation unit 80 (Step S006). The traffic-amount-per-terminal prediction unit 95 predicts the future traffic amount per terminal on the basis of the future traffic amount for each link and the number of terminals in communication (Step S007).

The traffic transmission duration time calculation unit 82e acquires the future traffic amount per terminal predicted by the traffic-amount-per-terminal prediction unit 95 and the average rate per terminal and the transmission cycle of the traffic per terminal acquired from the lower-order devices 3. The traffic transmission duration time calculation unit 82e calculates the transmission duration time of the traffic per terminal on the basis of the future traffic amount per terminal, the average rate per terminal, and the transmission cycle of the traffic per terminal (Step S008).

The congestion terminal number calculation unit 88 acquires the future traffic amount per terminal predicted by the traffic-amount-per-terminal prediction unit 95 and the link rate and the prediction accuracy acquired from the upper-order devices 4. The congestion terminal number calculation unit 88 calculates the maximum number of connected terminals within the range in which congestion will not occur on the basis of the future traffic amount per terminal, the link rate, and the prediction accuracy (Step S009).

The congestion duration rate calculation unit 96 acquires the transmission duration time of the traffic per terminal calculated by the traffic transmission duration time calculation unit 82e, the maximum number of connected terminals within the range in which congestion will not occur calculated by the congestion terminal number calculation unit 88, and the number of terminals in communication estimated by the communication terminal number estimation unit 80. The congestion duration rate calculation unit 96 calculates the congestion duration rate on the basis of the transmission duration time of the traffic per terminal, the maximum number of connected terminals within the range in which congestion will not occur, and the number of terminals in communication (Step S010).

On the other hand, the prediction unit 71 calculates the future traffic amount of the upper-order link in a period D(b) which is a period later than the period D(a) (Step S011). The switching determination unit 75e acquires the switching threshold value output in Step S005 from the threshold value calculation unit 74 (Step S012). Furthermore, the switching determination unit 75 acquires, from the prediction unit 71, the future traffic amount in the period D(b) calculated in Step S011 (Step S013). The switching determination unit 75 determines whether or not to switch the communication paths on the basis of the switching threshold value and the future traffic amount in the period D(b) (Step S014).

As described above, the future traffic amount acquired by the switching threshold value determination unit 72 is a traffic amount at a clock time earlier than the future traffic amount acquired by the switching determination unit 75.

As described above, the communication system 1e according to the fifth embodiment predicts the future traffic amount of the upper-order link in the period D(a) and calculates the prediction accuracy on the basis of the future traffic amount and the actual traffic amount. The communication system 1e determines the switching threshold value on the basis of the link rate of the upper-order link and the prediction accuracy. Then, the communication system 1e predicts the future traffic amount of the upper-order link in the period D(b) and determines whether or not to switch the communication paths on the basis of the switching threshold value, the future traffic amount, and the congestion duration rate.

As described above, the path switching requires a certain time (for example, the switching delay time and the switch-back delay time). In addition, the time (switching delay) required for such path switching is also a factor of the communication delay. Therefore, the communication delay accompanying the switching of the communication paths may be above the communication delay accompanying congestion in a case where switching of the communication paths frequently occurs even if the future traffic amount of the upper-order link is predicted and the congestion state is avoided. In this case, the communication delay cannot be reduced. On the other hand, the communication system 1e according to the fifth embodiment can reduce the communication delay (congestion delay) accompanying congestion in consideration of the switching delay.

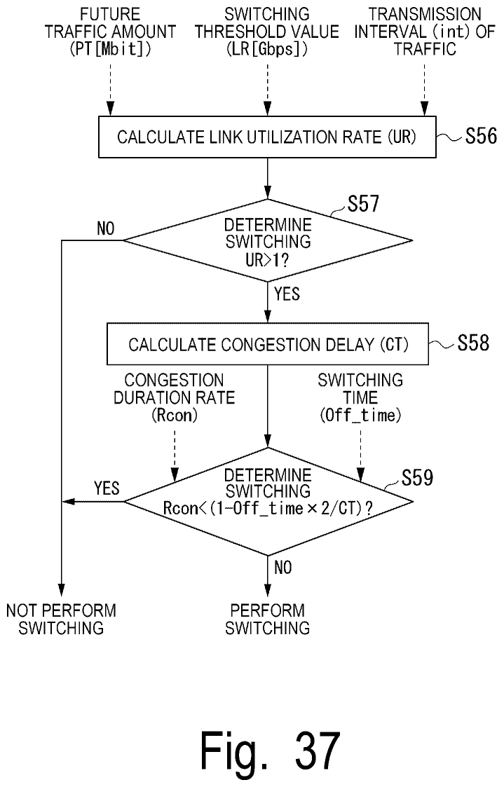

Hereinafter, processing of determining whether or not to perform the path switching performed by the switching determination unit 75e will be explained in more detail. FIG. 37 is a flowchart illustrating a flow of the processing of determining whether or not to perform the path switching by the switching determination unit 75e according to the fifth embodiment of the present invention.

The switching determination unit 76 based on the traffic amount calculates the utilization rate (UR) of the link on the basis of the future traffic amount (PT), the switching threshold value (LR), and the transmission interval (int) of the traffic (Step S56). The utilization rate (UR) of the link is calculated by Expression (17) described above, for example.

The switching determination unit 76 based on the traffic amount determines whether or not to perform the path switching due to occurrence of congestion on the basis of whether or not UR>1 is established (Step S57). In a case where the switching determination unit 76 based on the traffic amount determines that congestion will not occur and the path switching is not to be performed (Step S57: No), the path switching is not executed.

In a case where the switching determination unit 76 based on the traffic amount determines that the path switching due to occurrence of congestion is to be performed (Step S57: Yes), the switching determination unit 79 based on the congestion duration rate calculates the congestion delay (CT) (Step S58). The congestion delay (CT) is calculated by Expression (18) described above, for example.

The switching determination unit 79 based on the congestion duration rate determines whether or not to perform the path switching on the basis of the congestion delay CT), the switching delay, and the congestion duration rate (Rcon) (Step S59). The switching determination unit 79 based on the congestion duration rate determines whether or not to perform the path switching on the basis of whether or not the value of the congestion duration rate (Rcon) is less than a value obtained by subtracting a value obtained by dividing the total value (Off_time×2) of the switch delay and the switch-back delay by the congestion delay (CT) from one (that is, whether or not Expression (38) below is satisfied).

$$Rcon < ( 1 - Off\_time \times 2 / CT ) \qquad ( 38 )$$

In a case where Expression (38) above is satisfied (Step S59: Yes), the switching determination unit 79 based on the congestion duration rate determines not to execute the path switching. Also, in a case where Expression (38) above is not satisfied (Step S59: No), the switching determination unit 79 based on the congestion duration rate determines to execute the path switching.

As described above, the processing of determining whether or not to perform the path switching performed by the switching determination unit 75e illustrated in the flowchart of FIG. 37 ends.

Note that although the determination of whether or not to perform the path switching is made by comparing the value of the congestion duration rate (Rcon) with the rate between the congestion delay (CT) and the switching delay (Off_time) in Step S51 described above according to the configuration, the present invention is not limited thereto. For example, a configuration may also be employed in which the value of the congestion duration rate (Rcon) is compared with a predefined constant value and the determination of whether or not to perform the path switching is made.

In addition, a value of an allowable delay may be used instead of the value of the switching delay in the processing of determining whether or not to perform the path switching in Step S51 described above. In other words, the switching determination unit 79 based on the congestion duration rate may determine whether or not to execute the path switching on the basis of whether or not Expression (39) below is satisfied. Note that “A\hat{ }B” represents “A^{B}”, for example.

$$Rcon \hat{} ( allowable delay / CT ) < ( 1 - Off\_time \times 2 / CT ) \qquad ( 39 )$$

As described above, the communication system 1e according to the fifth embodiment of the present invention calculates the future traffic amount for each link and estimates the number of terminals in communication. The communication system 1e predicts a future traffic amount per terminal on the basis of the future traffic amount and the number of terminals in communication. The communication system 1e calculates the transmission duration time of the traffic per terminal on the basis of the future traffic amount per terminal, the average rate per terminal, and the transmission cycle of the traffic per terminal. The communication system 1e calculates the maximum number of connected terminals within the range in which congestion will not occur on the basis of the future traffic amount per terminal, the link rate, and the prediction accuracy. The communication system 1e calculates the congestion duration rate on the basis of the transmission duration time of the traffic per terminal, the maximum number of connected terminals within a range in which congestion will not occur, and the number of terminals in communication. Then, the communication system 1e calculates the utilization rate of the link on the basis of the future traffic amount, the switching threshold value, and the transmission interval of the traffic. The communication system 1e determines whether or not congestion will occur on the basis of the utilization rate of the link. In a case where it is determined that congestion will occur, the communication system 1e determines whether or not the value of the congestion duration rate is equal to or greater than the ratio between the total time of the delay times of the switch delay and the switch-back delay and the congestion time. In a case where the value of the congestion duration rate is equal to or greater than the ratio, the communication system 1e determines to execute the path switching.

According to the communication system 1e with such a configuration, the path switching is not performed in a case where the congestion duration rate is relatively not high in a situation in which the switching of the communication paths frequently occurs. In this manner, the communication system 1e according to the fifth embodiment of the present invention can reduce the communication delay due to congestion in consideration of the communication delay due to switching of the communication paths.

Although the exemplary case in which the lower-order devices 3 are, for example, DUs, the upper-order devices 4 are, for example, CUs, and the switching instruction device 7 and the like are transfer devices (switching devices) between the DUs and the CUs is assumed in each of the embodiments explained above, the present invention is not limited thereto. For example, the lower-order devices may be, for example, CUs, the upper-order devices may be, for example, user plane functions (UPFs), and the switching instruction device may be a router between the CUs and the UPFs.

According to the aforementioned embodiments, the communication control device includes the prediction unit (the predictor), the prediction accuracy calculation unit (the prediction accuracy calculation unit), the threshold value calculation unit (the threshold value calculator), the communication terminal number estimation unit (the communication terminal number estimator), the transmission duration time calculation unit (the transmission duration time calculator), the congestion determination unit (the congestion determinator), and the path switching determination unit (the path switching determinator). For example, the communication control device is the switching instruction devices 7a to 7e in the embodiments, the prediction unit is the prediction unit 71 in the embodiments, the prediction accuracy calculation unit is the prediction accuracy calculation unit 73 in the embodiments, the threshold value calculation unit is the threshold value calculation unit 74 in the embodiments, the communication terminal number estimation unit is the communication terminal number estimation unit 80 in the embodiments, the transmission duration time calculation unit is the traffic transmission duration time calculation unit 82 in the embodiments, the congestion determination unit is the switching determination unit 76 based on the traffic amount in the embodiments, and the path switching determination unit is the switching determination unit 77 based on the congestion duration time in the embodiments, the switching determination unit 78 based on the congestion time or the switching determination unit 79 based on the congestion duration rate.

The prediction unit described above predicts a future traffic amount of the communication link on the basis of prediction information used to predict the traffic amount. The prediction accuracy calculation unit described above calculates prediction accuracy on the basis of the traffic amount of the communication link in the first period predicted by the prediction unit and the actual traffic amount of the communication link in the first period. For example, the first period is the period D(a) in the embodiments. The threshold value calculation unit described above calculates a threshold value used to determine whether or not congestion will occur on the basis of the prediction accuracy calculated by the prediction accuracy calculation unit and a transmission ability of the communication link. For example, the transmission ability of the communication link is the link rate in the embodiments, and the threshold value is the switching threshold value in the embodiments. The communication terminal number estimation unit described above estimates the number of terminals in communication, which is the number of terminals that are performing communication through the communication link. The transmission duration time calculation unit described above calculates a transmission duration time of the traffic per terminal on the basis of the traffic amount in a second period, which is a period later than the first period, predicted by the prediction unit, the number of terminals in communication estimated by the communication terminal number estimation unit, the average rate per terminal, the transmission cycle of the traffic, and the transmission interval of the traffic. For example, the second period is the period D(b) in the embodiments. The congestion determination unit described above determines whether or not congestion will occur on the basis of the traffic amount in the second period predicted by the prediction unit and the threshold value calculated by the threshold value calculation unit. In a case where the congestion determination unit determines that congestion will occur, the path switching determination unit determines whether or not to perform the path switching to reduce the traffic amount of the communication link on which occurrence of congestion is predicted on the basis of the time calculated using the transmission duration time calculated by the transmission duration time calculation unit, or provides an instruction to switch the paths to the transfer device configuring the communication network in a case where it is determined to be necessary to perform the path switching. For example, the time calculated using the transmission duration time is the congestion duration time, the congestion duration time, or the congestion duration time or the congestion duration rate in the embodiments, the communication network is the network 5 in the embodiments, and the transfer device is the transfer device 15 in the embodiments.

Note that the communication control device described above may further include a congestion duration time calculation unit (a congestion duration time calculator). For example, the congestion duration time calculation unit is the congestion duration time calculation unit 84 in the embodiments.

The congestion duration time calculation unit described above calculates the congestion duration time which is the duration time of congestion on the basis of the transmission duration time, the number of terminals in communication, the transmission cycle of the traffic, and the transmission interval of the traffic. In addition, the path switching determination unit described above determines that it is necessary to perform the path switching in a case where the delay time based on the congestion duration time calculated by the congestion duration time calculation unit is longer than the delay time caused by the path switching. For example, the delay time based on the congestion duration time is the congestion delay in the embodiments, and the delay time caused by the path switching is the switching delay in the embodiments.

Note that the communication control device described above may further include a congestion time calculation unit (a congestion time calculator). For example, the congestion time calculation unit is the congestion time calculation unit 89 in the embodiments. The congestion time calculation unit described above calculates the congestion time occurring in a period later than the second period on the basis of the transmission duration time, the number of terminals in communication, the transmission cycle of the traffic, the transmission interval of the traffic, the prediction accuracy, and the transmission ability of the communication link. In addition, the path switching determination unit described above determines that it is necessary to perform the path switching in a case where the delay time based on the congestion time calculated by the congestion time calculation unit is longer than the delay time caused by the path switching.

Note that the communication control device described above may further include a traffic amount prediction unit (a traffic amount predictor), a congestion terminal number calculation unit (a congestion terminal number calculator), and a congestion duration rate calculation unit (a congestion duration rate calculator). For example, the traffic amount prediction unit is the traffic-amount-per-terminal prediction unit 95 in the embodiments, the congestion terminal number calculation unit is the traffic transmission duration time calculation unit 82e in the embodiments, and the congestion duration rate calculation unit is the congestion duration rate calculation unit 96 in the embodiments. The traffic amount prediction unit described above calculates the future traffic amount per terminal on the basis of the number of terminals in communication and the future traffic amount. The congestion terminal number calculation unit described above calculates the maximum number of connected terminals which is the maximum number of connected terminals within the range in which congestion will not occur on the basis of the future traffic amount per terminal predicted by the traffic amount prediction unit, the prediction accuracy, and the transmission ability of the communication link. The congestion duration rate calculation unit calculates the congestion duration rate on the basis of the transmission duration time, the number of terminals in communication, and the maximum number of connected terminals. Also, the path switching determination unit described above determines that it is necessary to perform the path switching on the basis of the congestion duration rate calculated by the congestion duration rate calculation unit and the ratio between the delay time caused by the path switching and the congestion time in the second period.

Note that in a case where it is determined to be necessary to perform the path switching, the path switching determination unit may provide an instruction to perform the path switching before the second period in the communication control device described above.

Note that the communication terminal number estimation unit may estimate the number of terminals in communication on the basis of information related to terminals in communication that is included in radio information transmitted from the terminals or a communication device that communicates with the terminals in the communication control device described above. For example, the terminal is the terminal stations 11 or the UEs in the embodiments, the communication device that communicates with the terminals is the lower-order devices 3 or the distributed stations 13 in the embodiments, and the information related to the terminals in communication is, for example, UE IDs, gNB-CU IDs, Number of active UEs, or the like.

Furthermore, according to the aforementioned embodiment, the communication system includes the communication device, the transfer device that configures a communication network and transfers signals transmitted or received by the communication device via a communication link, and the communication control device that performs traffic control in the communication network. For example, the communication system is the communication systems 1a to 1e in the embodiments, the communication device is the lower-order devices 3 and the upper-order devices 4, or the distributed stations 13 and the aggregation stations 14 in the embodiments, the communication network is the network 5 in the embodiments, the transfer device is the transfer device 15 in the embodiments, and the communication control device is the switching instruction devices 7a to 7e in the embodiments.

A part or an entirety of the configurations of the switching instruction devices 7a to 7e according to the aforementioned embodiments may be implemented by computers. In that case, a program for implementing the functions may be recorded in a computer-readable recording medium, and the program recorded in the recording medium may be read and executed by a computer system to implement the functions. Note that the “computer system” referred to herein includes an OS and hardware such as peripheral equipment. In addition, the “computer-readable recording medium” refers to a portable medium such as a flexible disk, a magneto-optical disk, a ROM, or a CD-ROM, or a storage device such as a hard disk incorporated in the computer system. Further, the “computer-readable recording medium” may include a medium that dynamically holds the program for a short period of time, such as a communication line in a case where the program is transmitted via a network such as the Internet or a communication line such as a telephone line, and a medium that holds the program for a certain period of time, such as a volatile memory inside a computer system serving as a server or a client in that case. Also, the program described above may be for implementing some of the functions described above, may further be able to implement the functions described above in combination with a program that has already been recorded in the computer system, or may be implemented using a programmable logic device such as a field programmable gate array (FPGA).

Although the embodiments of the present invention have been described in detail with reference to the drawings, specific configurations are not limited to the embodiments and include design and the like within the gist of the present invention.

### REFERENCE SIGNS LIST

1, 1a, 1b, 1c, 1d, 1e Communication system
3, 3-1 to 4 Lower-order device
4, 4-1 to 2 Upper-order device
5 Network
7, 7a, 7b, 7c, 7d, 7e Switching instruction device
10 Mobile communication system
11 Terminal station
12, 12-m Antenna station
13, 13-1 to m to M Distributed station
14, 14-1 to n to N Aggregation station
15 Transfer device
16 Resource allocation device
17 Switching instruction device
20 Upper-order network
71 Prediction unit
72 Switching threshold value determination unit
73 Prediction accuracy calculation unit
74 Threshold value calculation unit
75, 75a, 75c . . . , 75e Switching determination unit
76 Switching determination unit based on traffic amount
77 Switching determination unit based on congestion duration time
78 Switching determination unit based on congestion time
79 Switching determination unit based on congestion duration rate
80 Communication terminal number estimation unit
81, 81a, 81b, 81c, 81d, 81e Future congestion estimation unit
82, 82e Traffic transmission duration time calculation unit
83 Congestion duration frequency calculation unit
84 Congestion duration time calculation unit
84b Congestion duration time acquisition unit
85 Congestion duration time information storage unit
86 Congestion-time-per-number-of-terminals calculation unit
87 Congestion-frequency-per-number-of-terminals calculation unit
88 Congestion terminal number calculation unit
89 Congestion time calculation unit
89d Congestion time acquisition unit
91 Maximum congestion time calculation unit
92 Congestion time information storage unit
95 Traffic amount prediction unit
96 Congestion duration rate calculation unit
171 Prediction unit
172 Switching threshold value determination unit
173 Prediction accuracy calculation unit
174 Threshold value calculation unit
175 Switching determination unit

1. A communication control device comprising:
a predictor that predicts a future traffic amount of a communication link on the basis of prediction information used to predict the traffic amount;
a prediction accuracy calculator that calculates prediction accuracy on the basis of the traffic amount of the communication link in a first period predicted by the predictor and the actual traffic amount of the communication link in the first period;
a threshold value calculator that calculates a threshold value used to determine whether or not congestion will occur on the basis of the prediction accuracy calculated by the prediction accuracy calculator and a transmission ability of the communication link;
a communication terminal number estimator that estimates the number of terminals in communication which is the number of terminals that are performing communication through the communication link;
a transmission duration time calculator that calculates a transmission duration time of the traffic per terminal on the basis of the traffic amount in a second period, which is a period later than the first period, predicted by the predictor, the number of terminals in communication estimated by the communication terminal number estimator, an average rate per terminal, a transmission cycle of traffic, and a transmission interval of the traffic;
a congestion determinator that determines whether or not the congestion will occur on the basis of the traffic amount in the second period predicted by the predictor and the threshold value calculated by the threshold value calculator; and
a path switching determinator that determines whether or not to perform path switching to reduce the traffic amount of the communication link, due to which occurrence of the congestion is predicted, on the basis of a time calculated using the transmission duration time calculated by the transmission duration time calculator in a case where the congestion determinator determines that the congestion will occur, the path switching determinator providing an instruction to perform the path switching to a transfer device configuring a communication network in a case where it is determined to be necessary to perform the path switching.

2. The communication control device according to claim 1, further comprising:
a congestion duration time calculator that calculates a congestion duration time which is a duration time of the congestion on the basis of the transmission duration time, the number of terminals in communication, the transmission cycle of the traffic, and the transmission interval of the traffic,
wherein the path switching determinator determines that it is necessary to perform the path switching in a case where a delay time based on the congestion duration time calculated by the congestion duration time calculator is longer than a delay time occurring due to the path switching.

3. The communication control device according to claim 1, further comprising:
a congestion time calculator that calculates a congestion time occurring in a period that is later than the second period on the basis of the transmission duration time, the number of terminals in communication, the transmission cycle of the traffic, the transmission interval of the traffic, the prediction accuracy, and the transmission ability of the communication link,
wherein the path switching determinator determines that it is necessary to perform the path switching in a case where a delay time based on the congestion time calculated by the congestion time calculator is longer than a delay time occurring due to the path switching.

4. The communication control device according to claim 1, further comprising:
a traffic amount predictor that calculates the future traffic amount per terminal on the basis of the number of terminals in communication and the future traffic amount;
a congestion terminal number calculator that calculates a maximum connection number which is a maximum number of connected terminals within a range in which the congestion does not occur, on the basis of the future traffic amount per terminal predicted by the traffic amount predictor, the prediction accuracy, and the transmission ability of the communication link; and
a congestion duration rate calculator that calculates a congestion duration rate on the basis of the transmission duration time, the number of terminals in communication, and the maximum connection number,
wherein the path switching determinator determines that it is necessary to perform the path switching on the basis of the congestion duration rate calculated by the congestion duration rate calculator and a ratio between a delay time caused due to the path switching and a congestion time in the second period.

5. The communication control device according to claim 1, wherein the path switching determinator provides the instruction to perform the path switching before the second period in a case where it is determined to perform the path switching.

6. The communication control device claim 1, wherein the communication terminal number estimator estimates the number of terminals in communication on the basis of information related to the terminals in communication included in radio information transmitted from terminals or a communication device that performs communication with the terminals.

7. A communication system comprising:
a communication device;
a transfer device that configures a communication network and transfers a signal transmitted or received by the communication device via a communication link; and
a communication control device that performs traffic control in the communication network,
wherein the communication control device includes
a predictor that predicts a future traffic amount of a communication link on the basis of prediction information used to predict the traffic amount,
a prediction accuracy calculator that calculates prediction accuracy on the basis of the traffic amount of the communication link in a first period predicted by the predictor and the actual traffic amount of the communication link in the first period;
a threshold value calculator that calculates a threshold value used to determine whether or not congestion will occur on the basis of the prediction accuracy calculated by the prediction accuracy calculator and a transmission ability of the communication link;
a communication terminal number estimator that estimates the number of terminals in communication which is the number of terminals that are performing communication through the communication link;
a transmission duration time calculator that calculates a transmission duration time of the traffic per terminal on the basis of the traffic amount in a second period, which is a period later than the first period, predicted by the predictor, the number of terminals in communication estimated by the communication terminal number estimator, an average rate per terminal, a transmission cycle of traffic, and a transmission interval of the traffic;
a congestion determinator that determines whether or not the congestion will occur on the basis of the traffic amount in the second period predicted by the predictor and the threshold value calculated by the threshold value calculator; and
a path switching determinator that determines whether or not to perform path switching to reduce the traffic amount of the communication link, due to which occurrence of the congestion is predicted, on the basis of a congestion measurement time calculated on the basis of the transmission duration time calculated by the transmission duration time calculator in a case where the congestion determinator determines that the congestion will occur, the path switching determinator providing an instruction to perform the path switching to the transfer device configuring a communication network in a case where it is determined to be necessary to perform the path switching.

8. A communication control method performed by a computer, comprising:
predicting a future traffic amount of a communication link on the basis of prediction information used to predict the traffic amount;
calculating prediction accuracy on the basis of the traffic amount of the communication link in a first period and the actual traffic amount of the communication link in the first period;
determining a threshold value used to determine whether or not congestion will occur on the basis of the prediction accuracy and a transmission ability of the communication link;
estimating the number of terminals in communication which is the number of terminals that are performing communication through the communication link;
calculating a transmission duration time of the traffic per terminal on the basis of the traffic amount in a second period, which is a period later than the first period, the number of terminals in communication, an average rate per terminal, a transmission cycle of traffic, and a transmission interval of the traffic;
determining whether or not the congestion will occur on the basis of the traffic amount in the second period and the threshold value determined in the threshold value determination step; and
determining whether or not to perform path switching to reduce the traffic amount of the communication link, due to which occurrence of the congestion is predicted, on the basis of a congestion duration time calculated on the basis of the transmission duration time in a case where it is determined that the congestion will occur, and providing an instruction to perform the path switching to a transfer device configuring a communication network in a case where it is determined to be necessary to perform the path switching.
